(19) United States
(12) Patent Application Publication
(10) Pub. No.: US 2023/0111784 A1
(43) Pub. Date: Apr. 13, 2023

(54) RECOMMENDATION DEVICE, SYSTEM, METHOD, AND NON-TRANSITORY COMPUTER-READABLE MEDIUMSTORING PROGRAM

(71) Applicant: NEC Corporation, Minato-ku, Tokyo (JP)

(72) Inventor: Honami YUKI, Tokyo (JP)

(73) Assignee: NEC Corporation, Minato-ku, Tokyo (JP)

(21) Appl. No.: 17/911,466

(22) PCT Filed: Mar. 30, 2020
(86) PCT No.: PCT/JP2020/014462

§ 371 Date: Sep. 14, 2022

(51) Int. Cl. G06Q 30/06; G06Q 20/40; G06V 40/16

(52) U.S. Cl. CPC G06Q 30/0631; G06Q 20/40145; G06V 40/168

(57) ABSTRACT

A recommendation device includes: a first acquisition unit configured to acquire an entrance time to a first store in a case where first face authentication has succeeded for a first captured image obtained by imaging a predetermined user when the user enters the first store; a second acquisition unit configured to acquire a payment time in a case where second face authentication has succeeded for a second captured image obtained by imaging the user when the user makes payment in the first store; a registration unit configured to register a first payment history based on the payment in association with the user; a calculation unit configured to calculate a first stay time of the user in the first store; a specifying unit configured to specify recommendation information based on the first payment history and the first stay time; and an output unit configured to output the recommendation information.

### TECHNICAL FIELD

The present invention relates to a recommendation device, a system, a method, and a non-transitory computer-readable medium storing a program, and more particularly, to a recommendation device, a system, a method, and a non-transitory computer-readable medium storing a program for providing recommendation information to a user.

### BACKGROUND ART

Patent Literature 1 discloses a technology related to a face image collation system. The face image collation system detects a face from an image captured by an imaging device installed at an entrance of a facility, and performs face collation based on an image captured by an imaging device installed at each store or an exit of the facility. Then, a date and time of face detection is set as an entrance date and time of a visitor, and a date and time of face collation is set as an exit date and time of a store or a facility. Thereafter, a stay time in a facility is calculated based on the entrance date and time and the exit date and time of a visitor, and behavior analysis is performed in consideration of the stay time of the visitor.

### Citation List

### Patent Literature

Patent Literature 1: International Patent Publication No. WO2018/180588

### SUMMARY OF INVENTION

### Technical Problem

The technology disclosed in Patent Literature 1 has a problem that it is only possible to grasp an entrance/leaving timing of a visitor to and from a store or facility, and thus behavior analysis for the visitor is insufficient.

The present disclosure has been made to solve such a problem, and an object of the present disclosure is to provide a recommendation device, a system, a method, and a non-transitory computer-readable medium storing a program for presenting effective recommendation information to a user.

### Solution to Problem

A recommendation device according to the present disclosure includes: a first acquisition unit configured to acquire a first time that is an entrance time to a first store in a case where first face authentication using an authentication device that stores face feature information of a plurality of registered users in advance has succeeded for a first captured image obtained by imaging a predetermined user when the user enters the first store; a second acquisition unit configured to acquire a second time that is a payment time in a case where second face authentication using the authentication device has succeeded for a second captured image obtained by imaging the user when the user makes payment in the first store; a registration unit configured to register a first payment history based on the payment in association with the user in storage means in a case where the second face authentication has succeeded; a calculation unit configured to calculate a first stay time of the user in the first store based on a difference between the first time and the second time; a specifying unit configured to specify recommendation information based on the first payment history and the first stay time; and an output unit configured to output the specified recommendation information.

A recommendation device according to the present disclosure includes: calculation means for calculating a stay time of a user in a store; specifying means for specifying recommendation information to be presented to the user based on the stay time; and output means for outputting the specified recommendation information.

A recommendation system according to the present disclosure includes: an imaging device configured to capture an image including a face region of a predetermined user; a payment terminal configured to perform payment for the user; a recommendation device configured to be communicable with the imaging device and the payment terminal; and an authentication device configured to store face feature information of the user and be communicable with the recommendation device, in which the recommendation device includes: a first acquisition unit configured to acquire a first time that is an entrance time to a first store in a case where first face authentication using an authentication device that stores face feature information of a plurality of registered users in advance has succeeded for a first captured image obtained by imaging a predetermined user when the user enters the first store; a second acquisition unit configured to acquire a second time that is a payment time in a case where second face authentication using the authentication device has succeeded for a second captured image obtained by imaging the user when the user makes payment in the first store; a registration unit configured to register a first payment history based on the payment in association with the user in storage means in a case where the second face authentication has succeeded; a calculation unit configured to calculate a first stay time of the user in the first store based on a difference between the first time and the second time; a specifying unit configured to specify recommendation information based on the first payment history and the first stay time; and an output unit configured to output the specified recommendation information.

A recommendation method according to the present disclosure performed by a computer includes: acquiring a first time that is an entrance time to a first store in a case where first face authentication using an authentication device that stores face feature information of a plurality of registered users in advance has succeeded for a first captured image obtained by imaging a predetermined user when the user enters the first store; acquiring a second time that is a payment time in a case where second face authentication using the authentication device has succeeded for a second captured image obtained by imaging the user when the user makes payment in the first store; registering a first payment history based on the payment in association with the user in storage means in a case where the second face authentication has succeeded; calculating a first stay time of the user in the first store based on a difference between the first time and the second time; specifying recommendation information based on the first payment history and the first stay time; and outputting the specified recommendation information.

A non-transitory computer-readable medium according to the present disclosure stores a program for performing: acquiring a first time that is an entrance time to a first store in a case where first face authentication using an authentication device that stores face feature information of a plurality of registered users in advance has succeeded for a first captured image obtained by imaging a predetermined user when the user enters the first store; acquiring a second time that is a payment time in a case where second face authentication using the authentication device has succeeded for a second captured image obtained by imaging the user when the user makes payment in the first store; registering a first payment history based on the payment in association with the user in storage means in a case where the second face authentication has succeeded; calculating a first stay time of the user in the first store based on a difference between the first time and the second time; specifying recommendation information based on the first payment history and the first stay time; and outputting the specified recommendation information.

A recommendation device according to the present disclosure includes: a first authentication unit configured to perform first face authentication by using face feature information of a plurality of registered users stored in advance, for a first captured image obtained by imaging a predetermined user when the user enters a first store; a first acquisition unit configured to acquire a first time that is an entrance time to the first store in a case where the first face authentication has succeeded; a second authentication unit configured to perform second face authentication by using the face feature information of the plurality of registered users, for a second captured image obtained by imaging the user when the user makes payment in the first store; a second acquisition unit configured to acquire a second time that is a payment time in a case where the second face authentication has succeeded; a registration unit configured to register a first payment history based on the payment in association with the user in storage means in a case where the second face authentication has succeeded; a calculation unit configured to calculate a first stay time of the user in the first store based on a difference between the first time and the second time; a specifying unit configured to specify recommendation information based on the first payment history and the first stay time; and an output unit configured to output the specified recommendation information.

A recommendation method according to the present disclosure performed by a computer includes: performing first face authentication by using face feature information of a plurality of registered users stored in advance, for a first captured image obtained by imaging a predetermined user when the user enters a first store; acquiring a first time that is an entrance time to the first store in a case where the first face authentication has succeeded; performing second face authentication by using the face feature information of the plurality of registered users, for a second captured image obtained by imaging the user when the user makes payment in the first store; acquiring a second time that is a payment time in a case where the second face authentication has succeeded; registering a first payment history based on the payment in association with the user in storage means in a case where the second face authentication has succeeded; calculating a first stay time of the user in the first store based on a difference between the first time and the second time; specifying recommendation information based on the first payment history and the first stay time; and outputting the specified recommendation information.

A non-transitory computer-readable medium according to the present disclosure stores a program for performing: performing first face authentication by using face feature information of a plurality of registered users stored in advance, for a first captured image obtained by imaging a predetermined user when the user enters a first store; acquiring a first time that is an entrance time to the first store in a case where the first face authentication has succeeded; performing second face authentication by using the face feature information of the plurality of registered users, for a second captured image obtained by imaging the user when the user makes payment in the first store; acquiring a second time that is a payment time in a case where the second face authentication has succeeded; registering a first payment history based on the payment in association with the user in storage means in a case where the second face authentication has succeeded; calculating a first stay time of the user in the first store based on a difference between the first time and the second time; specifying recommendation information based on the first payment history and the first stay time; and outputting the specified recommendation information.

### Advantageous Effects of Invention

According to the present disclosure, it is possible to provide the recommendation device, the system, the method, and the non-transitory computer-readable medium storing the program for presenting effective recommendation information to a visitor.

### BRIEF DESCRIPTION OF DRAWINGS

FIG. 1 is a block diagram illustrating a configuration of a recommendation device according to a first example embodiment.

FIG. 2 is a flowchart illustrating a flow of a recommendation method according to the first example embodiment.

FIG. 3 is a block diagram illustrating a configuration of a recommendation device according to a second example embodiment.

FIG. 4 is a flowchart illustrating a flow of a recommendation method according to the second example embodiment.

FIG. 5 is a block diagram illustrating a configuration of a recommendation system according to a third example embodiment.

FIG. 6 is a block diagram illustrating a configuration of an authentication device.

FIG. 7 is a flowchart illustrating a flow of face feature information registration processing.

FIG. 8 is a flowchart illustrating a flow of face authentication processing.

FIG. 9 is a block diagram illustrating a configuration of a payment terminal.

FIG. 10 is a block diagram illustrating a configuration of a recommendation device.

FIG. 11 is a flowchart illustrating a flow of recommendation processing.

FIG. 12 is a flowchart illustrating a flow of store entrance time acquisition processing.

FIG. 13 is a flowchart illustrating a flow of payment time acquisition processing.

FIG. 14 is a view illustrating an example of a recommendation information screen displayed on a display terminal.

FIG. 15 is a view illustrating an example of a map displayed on the display terminal.

FIG. 16 is a view illustrating an action history displayed on the display terminal.

FIG. 17 is a block diagram illustrating a configuration of a recommendation system according to a fourth example embodiment.

FIG. 18 is a block diagram illustrating a configuration of a recommendation device according to the fourth example embodiment.

FIG. 19 is a flowchart illustrating a flow of recommendation processing.

FIG. 20 is a flowchart illustrating the flow of the recommendation processing.

FIG. 21 is a flowchart illustrating a flow of store entrance time acquisition processing.

FIG. 22 is a flowchart illustrating a flow of stay time calculation processing.

FIG. 23 is a block diagram illustrating a configuration of a recommendation system according to a fifth example embodiment.

FIG. 24 is a block diagram illustrating a configuration of a user terminal.

FIG. 25 is a flowchart illustrating a flow of recommendation processing.

### EXAMPLE EMBODIMENT

Hereinafter, example embodiments of the present disclosure will be described in detail with reference to the drawings. In the drawings, the same or corresponding elements are denoted by the same reference signs, and an overlapping description is omitted as necessary for clarity of description.

### First Example Embodiment

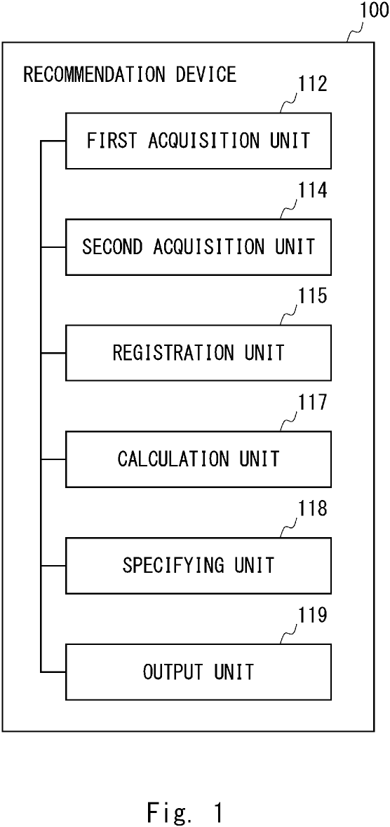

FIG. 1 is a block diagram illustrating a configuration of a recommendation device 100 according to a first example embodiment. The recommendation device 100 includes a first acquisition unit 112, a second acquisition unit 114, a registration unit 115, a calculation unit 117, a specifying unit 118, and an output unit 119. The recommendation device 100 is connected to a network 500 (not illustrated). The network 500 may be a wired network or a wireless network. An authentication device 200, an imaging device, a payment terminal 400, and the like (not illustrated) are connected to the network 500.

In a case where first face authentication using the authentication device 200 that stores face feature information of a plurality of registered users in advance has succeeded for a first captured image obtained by imaging a predetermined user when the user enters a first store, the first acquisition unit 112 acquires a first time that is an entrance time to the store. In a case where second face authentication using the authentication device 200 has succeeded for a second captured image obtained by imaging the user when the user makes payment in the first store, the second acquisition unit 114 acquires a second time that is a payment time.

Once the second face authentication succeeds, the registration unit 115 registers, in a storage unit 120 (not illustrated), a first payment history based on the payment made by the user whose face authentication has succeeded in association with the user. The calculation unit 117 calculates a first stay time of the user in the first store based on a difference between the first time and the second time. The specifying unit 118 specifies recommendation information based on the first payment history and the first stay time. The output unit 119 outputs the recommendation information specified by the specifying unit 118 to a display terminal. The display terminal is, for example, a user terminal, the payment terminal 400, a signage, or the like. The user terminal is a communication terminal such as a smartphone carried by a user. The signage is a terminal installed on a street or the like, and displays, for example, “how about visiting ◯◯ next?” or the like when a user stands in front of the signage.

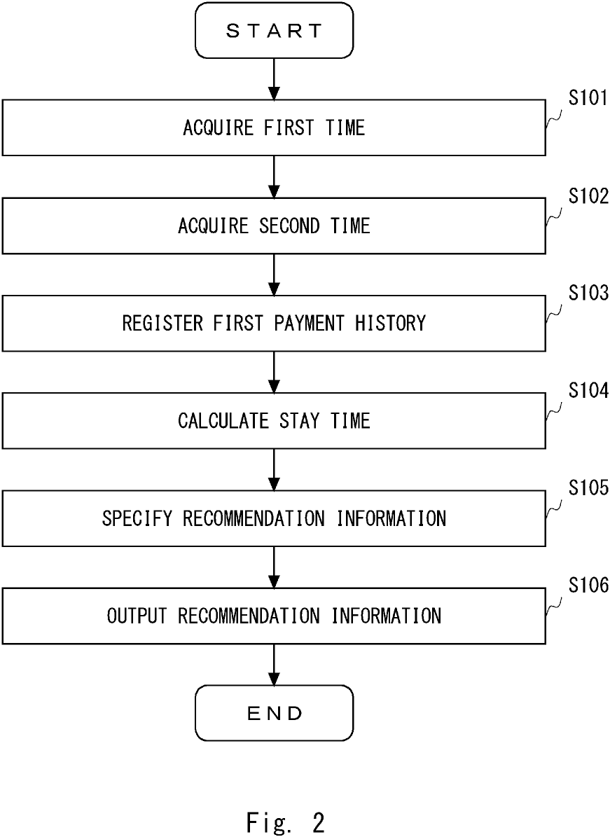

FIG. 2 is a flowchart illustrating a flow of a recommendation method according to the first example embodiment. First, in a case where the first face authentication using the authentication device that stores face feature information of a plurality of registered users in advance has succeeded for the first captured image obtained by imaging a predetermined user when the user enters the first store, the first acquisition unit 112 acquires the first time (Step S101). Note that, before Step S101, the authentication device 200 collates face feature information included in the first captured image with the face feature information registered in the authentication device 200, and performs the first face authentication for determining whether or not the authentication is successful based on whether or not the pieces of face feature information match each other. In a case where the first face authentication has succeeded, the authentication device 200 includes, in the determination result, a user ID for which the authentication has succeeded, and transmits the determination result as a response to the recommendation device 100.

Next, in a case where the second face authentication using the authentication device has succeeded for the second captured image obtained by imaging the user when the user makes payment in the first store, the second acquisition unit 114 acquires the second time, which is the payment time (Step S102). Note that, before Step S102, the authentication device 200 collates face feature information included in the second captured image with the face feature information registered in the authentication device 200, and performs the second face authentication for determining whether or not the authentication is successful based on whether or not the pieces of face feature information match each other. In a case where the second face authentication has succeeded, the authentication device 200 includes, in the determination result, a user ID for which the authentication has succeeded, and transmits the determination result as a response to the recommendation device 100.

Next, once the second face authentication has succeeded, the registration unit 115 registers, in the storage unit 120, the first payment history based on the payment in association with the user (Step S103). Next, the calculation unit 117 calculates the first stay time of the user in the first store based on the difference between the first time and the second time (Step S104). Next, the specifying unit 118 specifies the recommendation information based on the first payment history and the first stay time (Step S105). Next, the output unit 119 outputs the specified recommendation information (Step S106). As described above, since the recommendation method according to the present example embodiment can present recommendation information based on a payment history of a user and a stay time in a store, it is possible to present effective recommendation information to a user.

Note that the recommendation device 100 includes a processor, a memory, and a storage device as components not illustrated. Furthermore, the storage device stores a computer program in which processing of the recommendation method according to the present example embodiment is implemented. Then, the processor reads the computer program from the storage device into the memory, and executes the computer program. As a result, the processor implements the functions of the registration unit, the first acquisition unit 112, the second acquisition unit 114, the registration unit 115, the calculation unit 117, the specifying unit 118, and the output unit 119.

Alternatively, each of the registration unit, the first acquisition unit 112, the second acquisition unit 114, the registration unit 115, the calculation unit 117, the specifying unit 118, and the output unit 119 may be implemented by dedicated hardware. In addition, some or all of the components of each device may be implemented by a general-purpose or dedicated circuitry, a processor, or the like, or a combination thereof. These may be implemented by a single chip or may be implemented by a plurality of chips connected via a bus. Some or all of the components of each device may be implemented by a combination of the above-described circuit or the like and a program. Furthermore, a central processing unit (CPU), a graphics processing unit (GPU), a field-programmable gate array (FPGA), or the like can be used as the processor.

Furthermore, in a case where some or all of the components of the recommendation device 100 are implemented by a plurality of information processing devices, circuits, and the like, the plurality of information processing devices, circuits, and the like may be arranged in a centralized manner or in a distributed manner. For example, the information processing devices, the circuits, and the like may be implemented in a form in which each of them is connected via a communication network, such as a client server system or a cloud computing system. Furthermore, the function of the recommendation device 100 may be provided in a software as a service (SaaS) format.

### Second Example Embodiment

A second example embodiment is a modification of the first example embodiment described above. The recommendation device 100 according to the first example embodiment performs face authentication by using the external authentication device 200. On the other hand, a recommendation device 600 according to the present example embodiment performs face authentication inside the recommendation device 600.

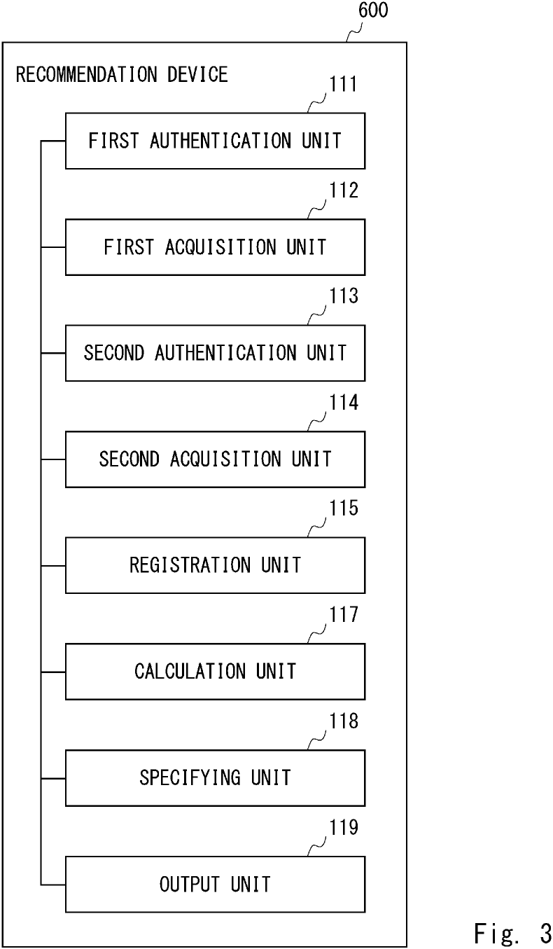

FIG. 3 is a block diagram illustrating a configuration of the recommendation device 600 according to the second example embodiment. The recommendation device 600 further includes a first authentication unit 111, a second authentication unit 113, and a face feature database (DB) (not illustrated) in addition to the components of the recommendation device 100 illustrated in FIG. 1. The face feature DB is a database that stores a user ID and face feature information in association with each other. For each component included in the recommendation device 600, a description overlapping with that of the first example embodiment will be omitted as appropriate.

The first authentication unit 111 performs first face authentication on a first captured image obtained by imaging a predetermined user when the user enters a first store by using face feature information of a plurality of registered users stored in advance. In the first face authentication, the first authentication unit 111 extracts face feature information from the first captured image, collates the face feature information with the face feature information stored in the face feature DB, and determines whether or not the authentication is successful based on whether or not the pieces of face feature information match each other. The face feature DB stores face feature information of a plurality of registered users. The first authentication unit 111 outputs a result indicating the success or failure of the first face authentication to the first acquisition unit 112. In a case where the first face authentication has succeeded, the first acquisition unit 112 acquires a first time that is an entrance time of the user to the store.

The second authentication unit 113 performs second face authentication on a second captured image obtained by imaging the user when the user makes payment in the first store by using the face feature information of the plurality of registered users stored in advance. In the second face authentication, the second authentication unit 113 extracts face feature information from the second captured image, collates the face feature information with the face feature information stored in the face feature DB, and determines whether or not the authentication is successful based on whether or not the pieces of face feature information match each other. The second authentication unit 113 outputs a result indicating the success or failure of the second face authentication to the second acquisition unit 114. In a case where the second face authentication has succeeded, the second acquisition unit 114 acquires a second time that is a payment time of the user.

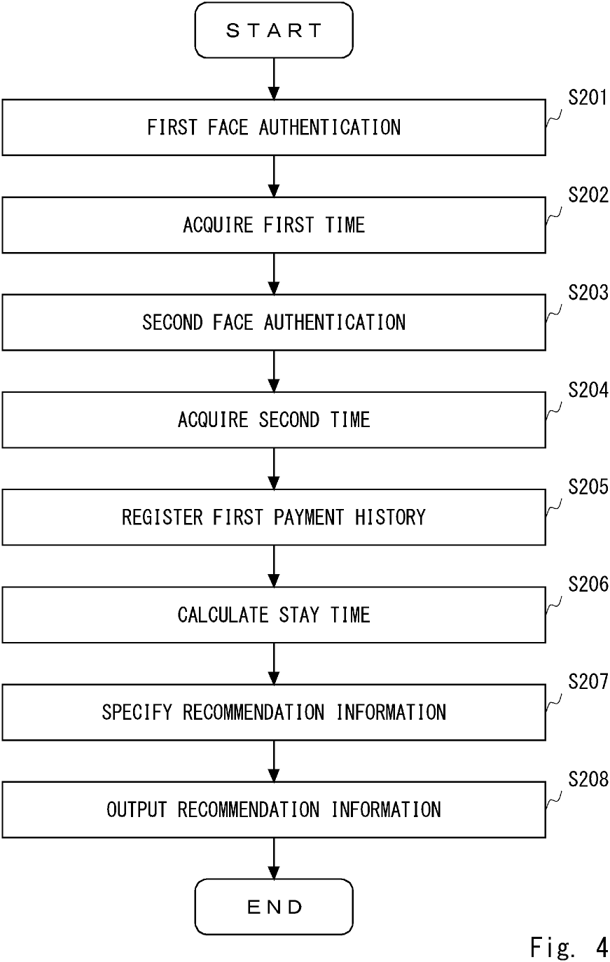

FIG. 4 is a flowchart illustrating a flow of a recommendation method according to the second example embodiment. First, the first authentication unit 111 performs the first face authentication on the first captured image obtained by imaging a predetermined user when the user enters the first store by using face feature information of a plurality of registered users stored in advance (Step S201). In a case where the first face authentication has succeeded, the first acquisition unit 112 acquires the first time, which is an entrance time to the store (Step S202).

Next, the second authentication unit 113 performs the second face authentication on the second captured image obtained by imaging the user when the user makes payment in the first store by using the face feature information of the plurality of registered users stored in advance (Step S203). In a case where the second face authentication has succeeded, the second acquisition unit 114 acquires the second time, which is a payment time (Step S204).

Next, once the second face authentication has succeeded, the registration unit 115 registers, in the storage unit 120, a first payment history based on the payment in association with the user (Step S205). Next, the calculation unit 117 calculates a first stay time of the user in the first store based on the difference between the first time and the second time (Step S206). Next, the specifying unit 118 specifies recommendation information based on the first payment history and the first stay time (Step S207). Next, the output unit 119 outputs the specified recommendation information (Step S208). Furthermore, the recommendation device according to the present example embodiment can achieve effects similar to the effects described in the first example embodiment.

### Third Example Embodiment

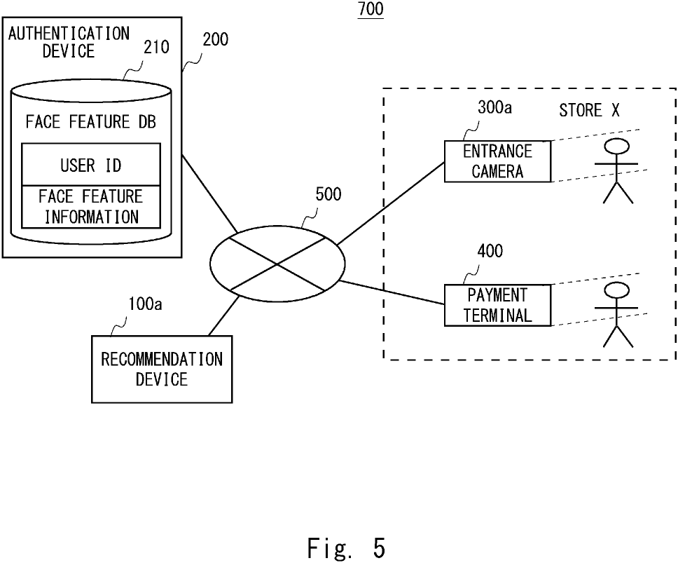

A third example embodiment is a specific example of the first example embodiment described above. FIG. 5 is a block diagram illustrating a configuration of a recommendation system 700 according to the third example embodiment. The recommendation system 700 includes a recommendation device 100a, an authentication device 200, an entrance camera 300a, and a payment terminal 400. Each of the recommendation device 100a, the authentication device 200, the entrance camera 300a, and the payment terminal 400 is connected via a network 500. Note that a description overlapping with the first example embodiment will be omitted as appropriate.

The recommendation device 100a is an information processing device for presenting predetermined recommendation information to a user who has made payment by face authentication in a store X, and is, for example, a server device implemented by a computer. The authentication device 200 is a device that performs first face authentication and second face authentication. The authentication device 200 includes a face feature DB 210. The face feature DB 210 is a face feature database that stores a user ID and face feature information of a corresponding user in association with each other. Note that the face feature DB 210 is an example of a face feature information storage unit.

The entrance camera 300a and the payment terminal 400 are installed in the store X. The entrance camera 300a is a terminal that captures a first captured image. Note that the entrance camera 300a is an example of an imaging device. The entrance camera 300a is, for example, a digital camera installed near the entrance of the store X, a digital signage equipped with a camera, or a face authentication terminal. The face authentication terminal may also serve as a display device. For example, the signage equipped with a camera may specify a user by performing face authentication and display recommendation information for the user. The entrance camera 300a captures the first captured image by imaging a user who has entered the store X. The entrance camera 300a transmits the first captured image to the recommendation device 100a via the network 500.

Note that, in a case where the recommendation system 700 is installed in a facility having a plurality of floors, entrance and payment made by a user may be recorded for each floor. In this case, the entrance camera 300a is installed near an entrance of each floor. The entrance of each floor is, for example, an exit of an escalator, an exit of an elevator, and an exit of a staircase. The entrance camera 300a captures the first captured image by imaging a user who has entered the floor.

The payment terminal 400 is an information processing device for performing payment when a user who has entered the store X makes a purchase in the store X. In addition, the payment terminal 400 captures an image including a face of a user who has made payment at the time of the payment as a second captured image, and transmits the second captured image to the recommendation device 100a via the network 500. For example, the payment terminal 400 may perform payment once the face authentication has succeeded. Specifically, the payment terminal 400 receives a face authentication result from the recommendation device 100a, performs payment processing in a case where the face authentication has succeeded, and transmits a payment history to the recommendation device 100a via the network 500. The payment history includes, for example, a date and time of payment, a payment amount, a payment content, and the like. The payment content is, for example, a purchased item and a purchased service.

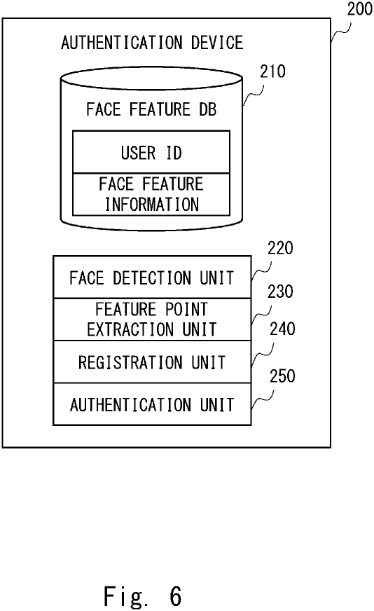

Next, a configuration of the authentication device 200 will be described in detail with reference to FIG. 6. FIG. 6 is a block diagram illustrating a configuration of the authentication device 200. The authentication device 200 includes the face feature DB 210, a face detection unit 220, a feature point extraction unit 230, a registration unit 240, and an authentication unit 250.

The face feature DB 210 is a face feature database that stores a user ID and face feature information of a corresponding user in association with each other. The face detection unit 220 detects a face region included in a captured image and outputs the face region to the feature point extraction unit 230. The feature point extraction unit 230 extracts a feature point from the face region detected by the face detection unit 220, and outputs face feature information to the registration unit 240. The face feature information is a set of extracted feature points.

The registration unit 240 newly issues a user ID when registering the face feature information. The registration unit 240 registers the issued user ID and the face feature information extracted from the registered image in association with each other in the face feature DB 210. The authentication unit 250 collates face feature information extracted from a face image with the face feature information in the face feature DB 210. The authentication unit 250 determines that the face authentication has succeeded in a case where the pieces of face feature information match each other, and determines that the face authentication has failed in a case where the pieces of face feature information do not match each other. The authentication unit 250 transmits a result indicating the success or failure of the face authentication as a response to the recommendation device 100a. Whether or not the pieces of face feature information match each other corresponds to the success or failure of the authentication. In addition, in a case where the face authentication has succeeded, the authentication unit 250 specifies a user ID associated with the face feature information for which the authentication has succeeded, and transmits an authentication result including the specified user ID and the fact that the authentication has succeeded to the recommendation device 100a.

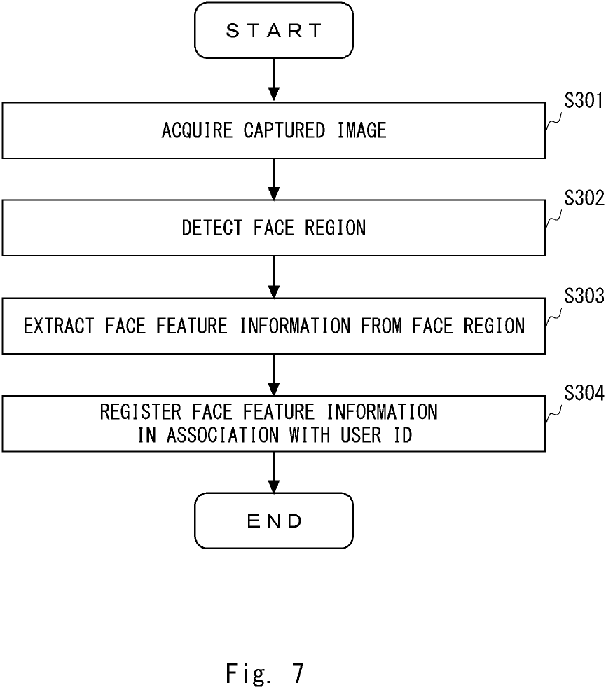

An operation of the authentication device 200 when registering a user ID and face feature information in the face feature DB 210 will be described with reference to FIG. 7. FIG. 7 is a flowchart illustrating a flow of face feature information registration processing.

When registering face feature information, a face information registration terminal (not illustrated) captures an image including a face of a user as a registration image, and transmits a face feature information registration request to the authentication device 200 via the network 500. The face information registration terminal is, for example, an information processing device such as a personal computer, a smartphone, or a tablet terminal. The face feature information registration request includes the registration image. First, the authentication device 200 acquires the registration image included in the face feature information registration request from the face information registration terminal via the network 500 (Step S301).

Next, the face detection unit 220 detects a face region included in the registration image (Step S302), and outputs the detected face region to the feature point extraction unit 230. Next, the feature point extraction unit 230 extracts a feature point from the face region and outputs face feature information to the registration unit 240 (Step S303). Next, the registration unit 240 issues a user ID corresponding to the output face feature information, and registers the user ID and the face feature information in association with each other in the face feature DB 210 (Step S304).

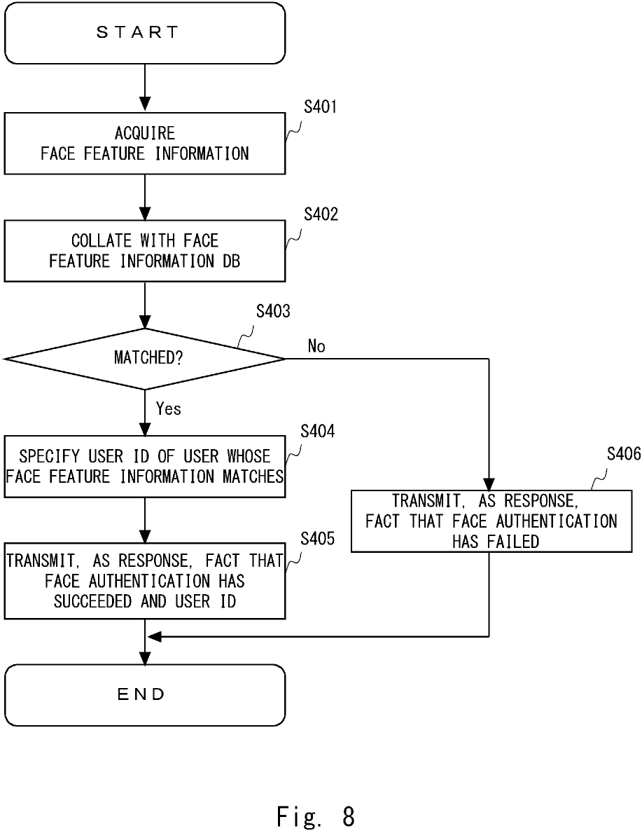

An operation of the authentication device 200 when performing the face authentication will be described with reference to FIG. 8. FIG. 8 is a flowchart illustrating a flow of face authentication processing. A case where the first face authentication is performed will be described in FIG. 8. However, the face authentication can be performed in a similar procedure also in a case where the second face authentication is performed.

Once a user enters the store X, the entrance camera 300a captures an image including a face of the user as the first captured image, and transmits the first captured image to the recommendation device 100a via the network 500. The recommendation device 100a extracts a face region or face feature information from the first captured image. The recommendation device 100a transmits the extracted face region or face feature information to the authentication device 200. The feature point extraction unit 230 acquires the face feature information by extracting the face feature information from the received face region or by receiving the face feature information (Step S401).

Next, the authentication unit 250 collates the acquired face feature information with that in the face feature DB 210 (Step S402). In a case where the pieces of face feature information match each other (Yes in Step S403), the authentication unit 250 specifies a user ID of the user whose face feature information matches (Step S404), and transmits, as a response, the fact that the face authentication has succeeded and the specified user ID to the recommendation device 100a (Step S405). In a case where there is no face feature information that matches with the acquired face feature information (No in Step S403), the authentication unit 250 transmits, as a response, the fact that the face authentication has failed to the recommendation device 100a (Step S406).

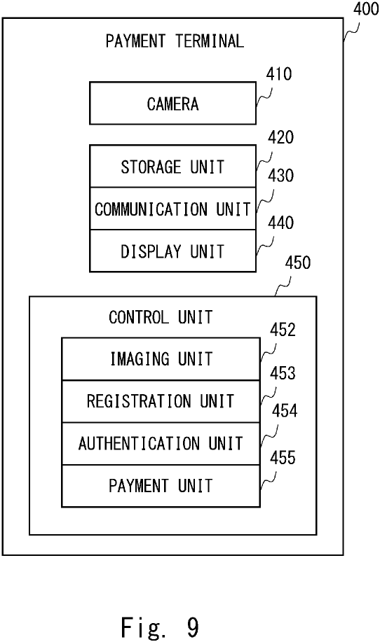

Next, a configuration of the payment terminal 400 will be described in detail with reference to FIG. 9. The payment terminal 400 includes an imaging device such as a camera, a display device, and a computer as hardware components. The payment terminal 400 is a device that performs capturing of the second captured image and payment processing.

FIG. 9 is a block diagram illustrating a configuration of the payment terminal 400. The payment terminal 400 includes a camera 410, a storage unit 420, a communication unit 430, a display unit 440, and a control unit 450. The camera 410 is an imaging device that captures an image. The storage unit 420 is a storage device that stores a program for implementing each function of the payment terminal 400. The communication unit 430 is a communication interface with the network 500. The display unit 440 is a display device that displays a face authentication result, recommendation information, and the like to a user. The control unit 450 controls hardware included in the payment terminal 400. The control unit 450 includes an imaging unit 452, a registration unit 453, an authentication unit 454, and a payment unit 455.

The imaging unit 452 transmits an imaging request to the camera 410. The camera 410 captures an image including a face of a user. The image captured by the camera 410 is used as the second captured image. The registration unit 453 transmits a history registration request to the recommendation device 100a via the network 500. Note that the history registration request includes a payment history that is a result of the payment processing. The payment history is, for example, information including a date and time of payment, the amount of money, an article, a user ID, and the like. The authentication unit 454 transmits a second face authentication request to the recommendation device 100a via the network 500, and receives the result from the recommendation device 100a. A result indicating the success or failure of the face authentication may be displayed on the display unit 440. The payment unit 455 performs the payment processing in a case where the face authentication has succeeded.

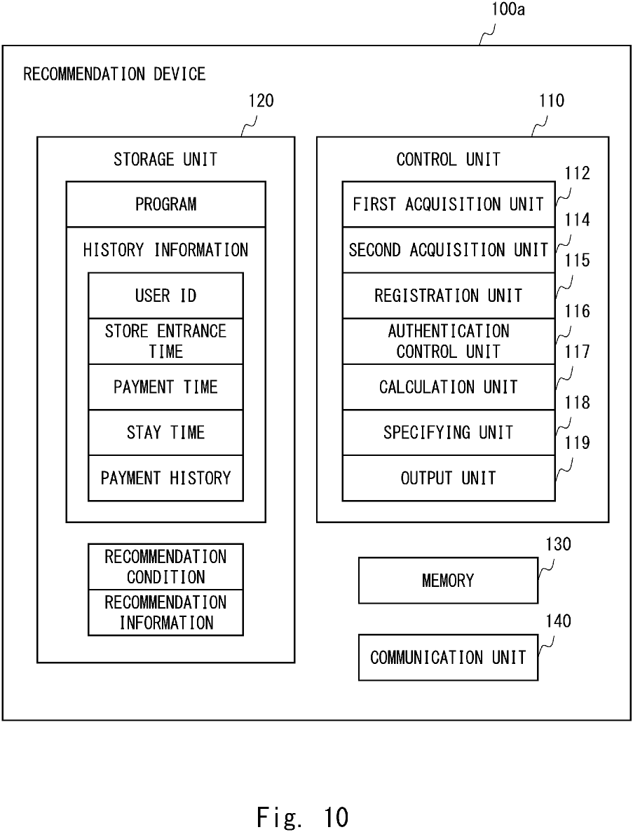

Next, a configuration of the recommendation device 100a will be described in detail with reference to FIG. 10. FIG. 10 is a block diagram illustrating a configuration of the recommendation device 100a. The recommendation device 100a includes a control unit 110, a storage unit 120, a memory 130, and a communication unit 140.

The storage unit 120 is a storage device that stores a program, history information, a recommendation condition, and recommendation information. Note that the storage unit 120 includes a history storage unit. The program is a computer program in which the recommendation processing according to the present example embodiment is implemented. The history information is information in which a user ID, a store entrance time, a payment time, a stay time, and a payment history are associated with each other. Note that, in the present example embodiment, the payment time is regarded as a store leaving time. The user ID is information enabling identification of a user who has entered the store and is to make payment, and is, for example, a name, a telephone number, an e-mail address, an arbitrary identification number, or the like. The stay time is a difference between the payment time and the store entrance time. The payment history includes a date and time of payment, a payment amount, a payment content, and the like.

The recommendation information is associated with the recommendation condition. The recommendation condition is a combination of a threshold value of the stay time and a condition for the magnitude thereof, and a condition for the payment history. The condition for the payment history is, for example, the type of a purchased product or the like, a threshold value of the payment amount and a condition for the magnitude thereof, a condition for the date and time of payment, and the like. The recommendation information is information to recommend a store, a product, and the like to, for example, a user who has entered the store X. The recommendation information is, for example, guidance of a discount sale of a specific product in the store X, introduction of another store in the same business as the store X, and the like.

The memory 130 is a storage region for temporarily storing processing contents of the control unit 110, and is, for example, a volatile storage device such as a random access memory (RAM). The communication unit 140 is an interface that communicates with the outside of the recommendation device 100a.

The control unit 110 includes a first acquisition unit 112, a second acquisition unit 114, a registration unit 115, an authentication control unit 116, a calculation unit 117, a specifying unit 118, and an output unit 119. The control unit 110 is a control device that controls the operation of the recommendation device 100a, and is, for example, a processor such as a CPU. The control unit 110 reads the program from the storage unit 120 into the memory 130 and executes the program. As a result, the control unit 110 implements the functions as the first acquisition unit 112, the second acquisition unit 114, the registration unit 115, the authentication control unit 116, the calculation unit 117, the specifying unit 118, and the output unit 119.

In a case where the first face authentication using the authentication device 200 has succeeded for the first captured image, the first acquisition unit 112 acquires a first time. Note that the authentication device 200 stores face feature information of a plurality of registered users in advance in association with user IDs of the plurality of registered users. The first captured image is an image captured when a predetermined user enters a first store, and includes a face region of the user. The first captured image is captured by the imaging device. The imaging device is, for example, the entrance camera 300a installed at an entrance of a store. The first time is a time at which a predetermined user enters the first store, for example, a time at which the first captured image is captured.

In a case where the second face authentication using the authentication device 200 has succeeded for the second captured image, the second acquisition unit 114 acquires a second time. The second captured image is an image captured when the predetermined user makes payment in the first store, and includes the face region of the user. The second captured image is captured by the camera included in the payment terminal 400. The second time is a time at which a predetermined user makes payment in the first store.

The registration unit 115 registers a first payment history in association with the user in the storage unit 120 once the second face authentication has succeeded. The first payment history is a history of payment made when the second face authentication has succeeded. The authentication control unit 116 extracts a face region or face feature information from the first captured image and the second captured image, and transmits the face region or the face feature information to the authentication device 200 to control to perform face authentication. In addition, the authentication control unit 116 receives a result indicating the success or failure of the face authentication from the authentication device 200. Note that, in a case where the face authentication has succeeded, the user ID is included in the face authentication result. The calculation unit 117 calculates a stay time of a user in the first store. The stay time is a difference between the first time and the second time.

The specifying unit 118 specifies recommendation information based on the first payment history and the first stay time. First, the specifying unit 118 acquires the first payment history and the first stay time from the storage unit 120. Next, the specifying unit 118 determines whether or not a combination of the first payment history and the first stay time satisfies a recommendation condition registered in advance in the storage unit 120. The specifying unit 118 compares each recommendation condition registered in the storage unit 120 with the first payment history and the first stay time, and specifies all matching recommendation conditions. Then, the specifying unit 118 specifies all pieces of recommendation information associated with all the specified recommendation conditions by reading them from the storage unit 120. The output unit 170 transmits the recommendation information specified by the specifying unit 160 to the display terminal via the network 500. The display terminal is, for example, a user terminal, the payment terminal 400, a signage, or the like.

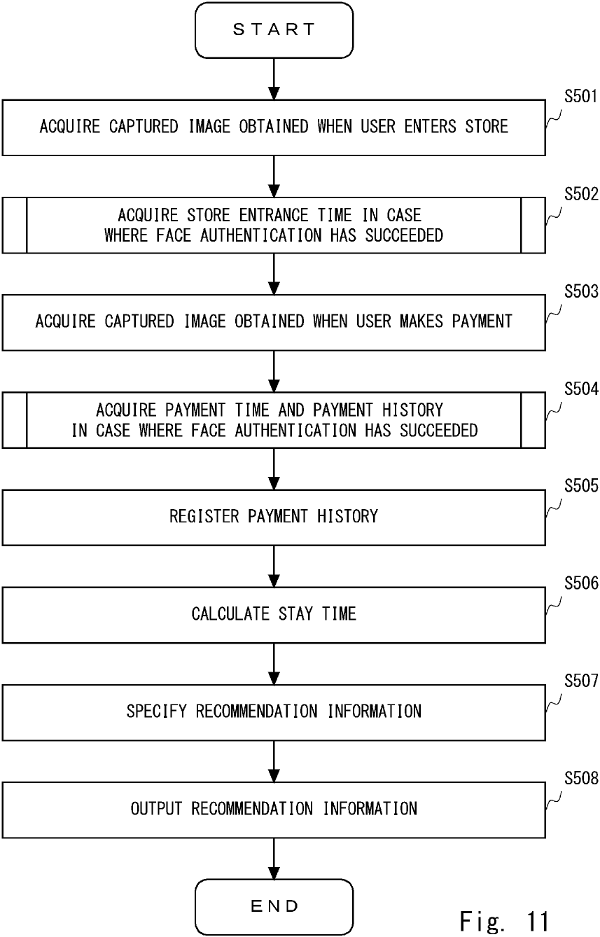

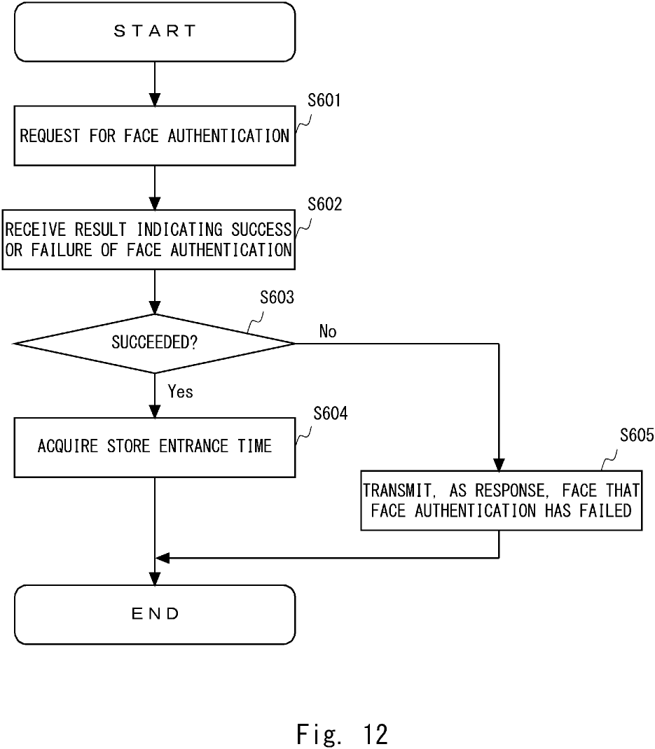

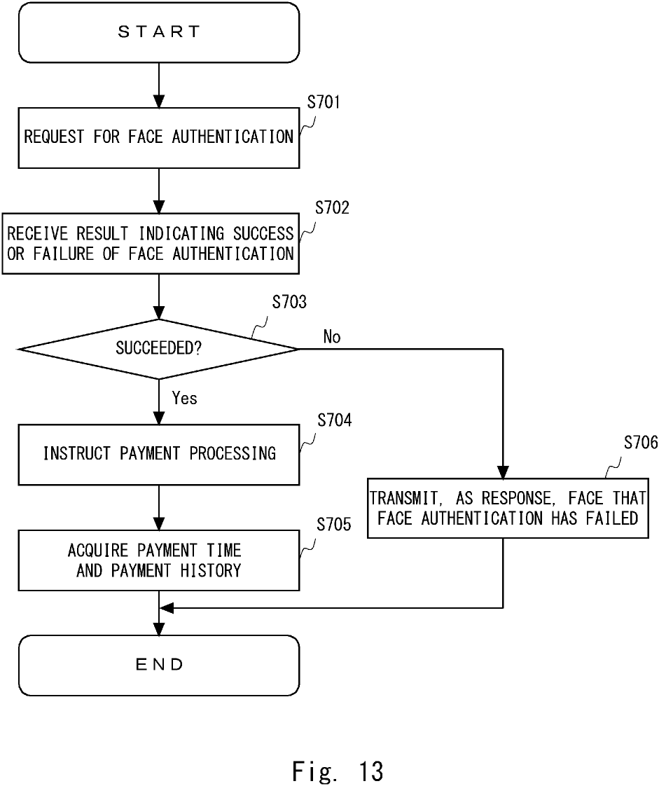

Next, an operation of the recommendation device 100a at the time of the recommendation processing will be described with reference to FIGS. 11 to 13. FIG. 11 is a flowchart illustrating a flow of the recommendation processing. FIG. 12 is a flowchart illustrating a flow of store entrance time acquisition processing. FIG. 13 is a flowchart illustrating a flow of payment time acquisition processing.

First, once a user enters the store X, the entrance camera 300a captures an image including a face of the user and transmits the captured image to the recommendation device 100a via the network 500. The authentication control unit 116 acquires the captured image (first captured image) obtained when the user enters the store by receiving the captured image from the entrance camera 300a (Step S501), and causes the authentication device 200 to perform the first face authentication. In a case where the first face authentication has succeeded, the first acquisition unit 112 acquires a store entrance time (first time) of the user (Step S502). Note that, in Step S502, the first acquisition unit 112 acquires an imaging time of the first captured image as the first time.

Next, the user makes payment in the store X. At the time of payment, the payment terminal 400 captures an image including the face of the user and transmits the captured image to the recommendation device 100a via the network 500. The authentication control unit 116 acquires the captured image (second captured image) obtained when the user makes payment by receiving the captured image from the payment terminal 400 (Step S503), and causes the authentication device 200 to perform the second face authentication. In a case where the second face authentication has succeeded, the second acquisition unit 114 instructs the payment terminal 400 to perform the payment processing, and acquires a payment time (second time) and a payment history of the user (Step S504).

Once the instruction for the payment processing is received, the payment terminal 400 performs the payment processing and transmits, as a response, the payment history, which is a result of the payment to the recommendation device 100a. In Step S504, the second acquisition unit 114 acquires the payment time included in the payment history and the payment history received from the payment terminal 400 as the second time and the payment history. Note that the payment terminal 400 transmits the payment history to the recommendation device 100a together with the second captured image in a case of making payment without depending on the face authentication. Examples of a method of making payment without depending on the face authentication include a method of making payment by using a credit card and a method of making payment by using electronic money.

Next, the registration unit 115 registers, in the storage unit 120, the payment history acquired by the second acquisition unit 114 in Step S504 (Step S505). Next, the calculation unit 117 calculates a stay time (first stay time) of the user in the store X (Step S506). Note that, although FIG. 11 illustrates a case where Step S506 is performed after Step S505, Step S506 may be performed before Step S505 or may be performed in parallel with Step S505. Next, the specifying unit 118 specifies recommendation information based on the first payment history and the first stay time (Step S507). Next, the output unit 119 outputs the recommendation information specified by the specifying unit 118 to the display terminal (Step S508).

Note that an output destination of the recommendation information in Step S508 may be a display device installed at a location different from a location where the stay time of the user is calculated. Furthermore, the output of the recommendation information (Step S508) may be performed immediately after the recommendation information is specified (Step S507), or may be performed after a while. That is, a timing at which the recommendation information is output may deviate from a timing at which the recommendation information is specified.

Step S502 will be described in detail with reference to FIG. 12. First, once the first captured image is acquired, the authentication control unit 116 extracts a face region or face feature information from the first captured image. Then, the authentication control unit 116 transmits a face authentication request including the extracted face region or face feature information to the authentication device 200 (Step S601). The authentication device 200 performs the first face authentication based on the received face region or face feature information, and transmits, as a response, an authentication result to the recommendation device 100a. The authentication control unit 116 receives the result indicating the success or failure of the first face authentication (Step S602).

In a case where the first face authentication has succeeded (Yes in Step S603), the first acquisition unit 112 acquires a time at which the first captured image is captured as the store entrance time of the user to the store X (Step S604). In a case where the first face authentication has failed (No in Step S603), the authentication control unit 116 transmits, as a response, the fact that the face authentication has failed to the first acquisition unit 112 (Step S605).

Step S504 will be described in detail with reference to FIG. 13. First, once the second captured image is acquired, the authentication control unit 116 extracts a face region or face feature information from the second captured image. Then, the authentication control unit 116 transmits a face authentication request including the extracted face region or face feature information to the authentication device 200 (Step S701). The authentication device 200 performs the second face authentication based on the received face region or face feature information, and transmits, as a response, an authentication result to the recommendation device 100a. The authentication control unit 116 receives the result indicating the success or failure of the second face authentication (Step S702).

In a case where the second face authentication has succeeded (Yes in Step S703), the second acquisition unit 114 instructs the payment terminal 400 to perform the payment processing (Step S704). Once the instruction for the payment processing is received, the payment terminal 400 performs the payment processing and transmits, as a response, the payment history, which is a result of the payment to the recommendation device 100a. The second acquisition unit 114 acquires a payment time and the payment history included in the payment history received from the payment terminal 400 as the payment time (second time) and the payment history. In a case where the second face authentication has failed (No in Step S703), the authentication control unit 116 transmits, as a response, the fact that the face authentication has failed to the second acquisition unit 114 (Step S706).

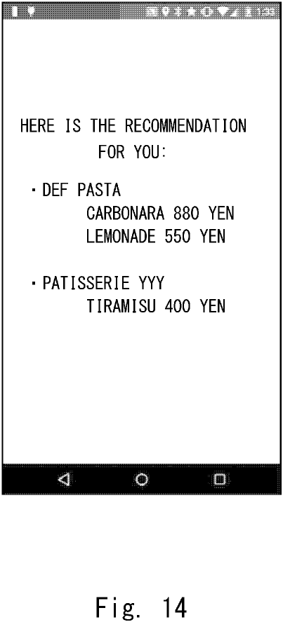

FIG. 14 is a view illustrating the recommendation information displayed on the display terminal. FIG. 14 illustrates a case where the recommendation information is displayed on the user terminal. As illustrated in FIG. 14, the user terminal displays the recommendation information received in Step S508 on a screen. Note that, in Step S508, the output unit 170 may transmit the payment history of the user to the display terminal in addition to the recommendation information.

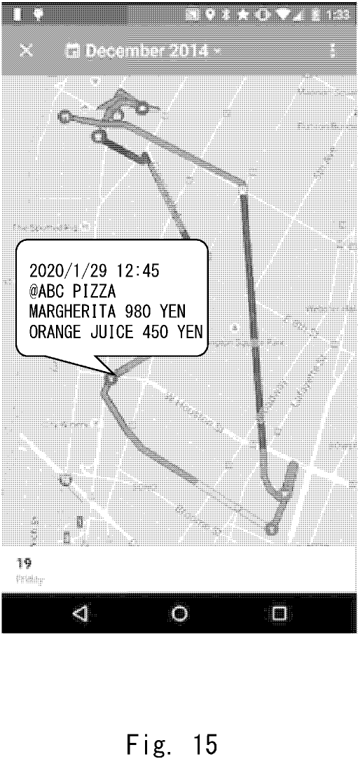

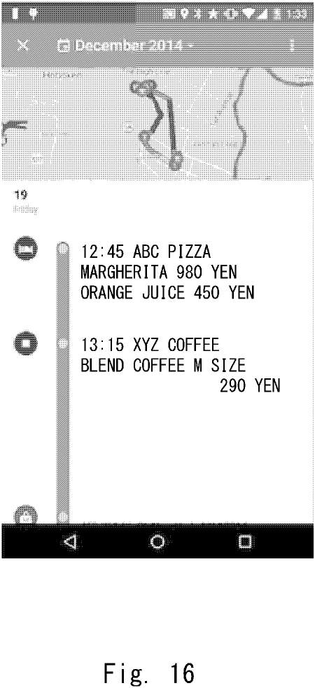

FIG. 15 is a view illustrating a map displayed as the payment history on the display terminal. As illustrated in FIG. 15, the user terminal may display the payment history of the user received in Step S508 on the map. Furthermore, FIG. 16 is a view illustrating the payment history displayed on the display terminal. As illustrated in FIG. 16, the user terminal may display the payment history received in Step S508 in time series.

FIGS. 15 and 16 illustrate a case where only the payment history of the user is displayed on the display terminal, but the recommendation information may be displayed in addition to the payment history on the display terminal. The recommendation information may include store information, an address of the store, route guidance from the current location of the user to the store, and the like. The route guidance may include a distance from the current location of the user to the store, a required time, and the like. Further, a plurality of pieces of recommendation information may be displayed on the display terminal. In a case where a plurality of pieces of recommendation information are displayed, details of each piece of recommendation information, route guidance, and the like may be simultaneously displayed. The user can examine the details of each piece of recommendation information, route guidance, and the like, and compare the pieces of recommendation information with each other.

Hereinafter, a specific example of the recommendation condition and corresponding recommendation information will be described. For example, in a case where the recommendation condition is that “the stay time is 30 minutes or more, and a meal price is included in the payment history”, the recommendation information is “guidance information to a predetermined restaurant”. The recommendation information may be “presentation of a discount coupon of a predetermined restaurant” or the like. A user staying for a long time and having a meal is considered to be interested in a restaurant. Therefore, presenting guidance to a predetermined restaurant to a user satisfying the above recommendation condition is presenting the recommendation information according to the interest of the user. Therefore, the utilization rate of the presented recommendation information can be increased.

In a case where the recommendation condition is that “the stay time is less than 30 minutes, and the meal price is included in the payment history”, the recommendation information is “guidance information to a predetermined fast food restaurant”. The recommendation information may be “presentation of a discount coupon of a predetermined fast food store” or the like. A user staying for a short time and having a meal is considered to be interested in a fast food restaurant. Furthermore, in a case where the recommendation condition is that “the stay time is less than 15 minutes, and a predetermined product purchase is included in the payment history”, the recommendation information is “purchased product arrival information”. The recommendation information may be “latest information of a purchased product” or the like. A user staying for a short time and purchasing a predetermined product is considered to have determined a product to be purchased in advance.

### Fourth Example Embodiment

A fourth example embodiment is a modification of the third example embodiment described above. The recommendation device 100a according to the third example embodiment acquires a store leaving time based on a payment history. On the other hand, in the fourth example embodiment, a store leaving time is acquired based on a captured image captured by an exit camera.

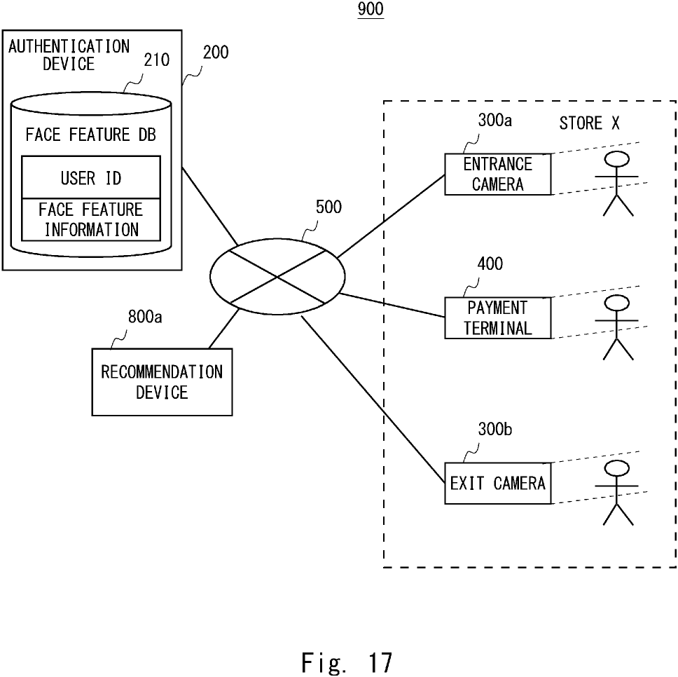

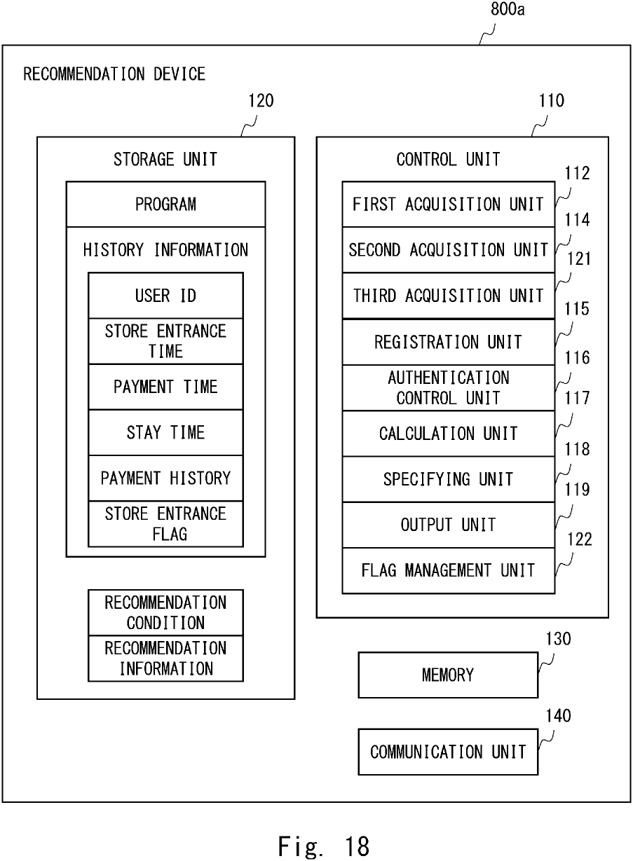

FIG. 17 is a block diagram illustrating a configuration of a recommendation system 900 according to the fourth example embodiment. In the recommendation system 900, the recommendation device 100a in the configuration of the recommendation system 700 illustrated in FIG. 5 is replaced with a recommendation device 800a, and an exit camera 300b is further included. Note that the exit camera 300b is an example of the imaging device. For each component included in the recommendation system 900, a description overlapping with that of the third example embodiment will be omitted as appropriate. FIG. 18 is a block diagram illustrating a configuration of the recommendation device according to the fourth example embodiment. The recommendation device 800a is different from the recommendation device 100a in that a third acquisition unit 121 and a flag management unit 122 are included. Since the other components are similar, a description thereof will be omitted as appropriate.

The exit camera 300b is, for example, a digital camera installed near an exit of a store X, a digital signage equipped with a camera, or a face authentication terminal. The exit camera 300b may be shared with the entrance camera 300a. Furthermore, the exit camera 300b may be a camera included in the payment terminal 400. The exit camera 300b captures a third captured image by imaging a user leaving the store X. The third captured image is an image captured when a predetermined user leaves the first store, and includes a face region of the user. The exit camera 300b transmits the third captured image to the recommendation device 800a via the network 500.

Note that, in a case where the recommendation system 900 is installed in a facility having a plurality of floors, entrance/leaving and payment made by a user may be recorded for each floor. In this case, the entrance camera 300a is installed near an entrance of each floor. The entrance camera 300a captures the first captured image by imaging a user who has entered the floor. The exit camera 300b is installed near an exit of each floor. The exit of each floor is, for example, an entrance of an escalator, an entrance of an elevator, and an entrance of a staircase. The exit camera 300b captures the third captured image by imaging a user leaving the floor.

In the present example embodiment, the authentication device 200 performs third face authentication in addition to the first face authentication and the second face authentication. The third face authentication is performed in the procedure illustrated in FIG. 8 similarly to the first face authentication and the second face authentication. The third acquisition unit 121 acquires a third time as the second time in a case where the third face authentication has succeeded and the user does not make payment in the store X. The third time is a time at which a predetermined user has left the first store, for example, a time at which the third captured image is captured. Once the third acquisition unit 121 acquires the third time, the registration unit 115 registers the fact that no payment has been made in the first store as the first payment history in the storage unit 120.

In the present example embodiment, the storage unit 120 includes a flag storage unit. The flag storage unit stores a store entrance flag of a user in association with a user ID. The store entrance flag is a flag for recording whether or not a user has entered the store X. The control unit 110 includes the flag management unit 122. The flag management unit 122 manages the store entrance flag. For example, in a case where the first face authentication has succeeded, the flag management unit 122 sets the store entrance flag of the user and registers the store entrance flag in flag storage means, and in a case where the second face authentication has succeeded, the flag management unit 122 resets the store entrance flag of the user and updates the flag storage means. Note that the implementation of the store entrance flag is not limited thereto.

In a case where the store entrance flag of the user is set in the flag storage unit, the third acquisition unit 121 considers that the user has made no payment in the first store. In a case where the third face authentication has succeeded and the store entrance flag of the user is set in the flag storage unit, the flag management unit resets the store entrance flag and updates the flag storage unit. The calculation unit 117 calculates the first stay time in a case where the store entrance flag of the user has been reset.

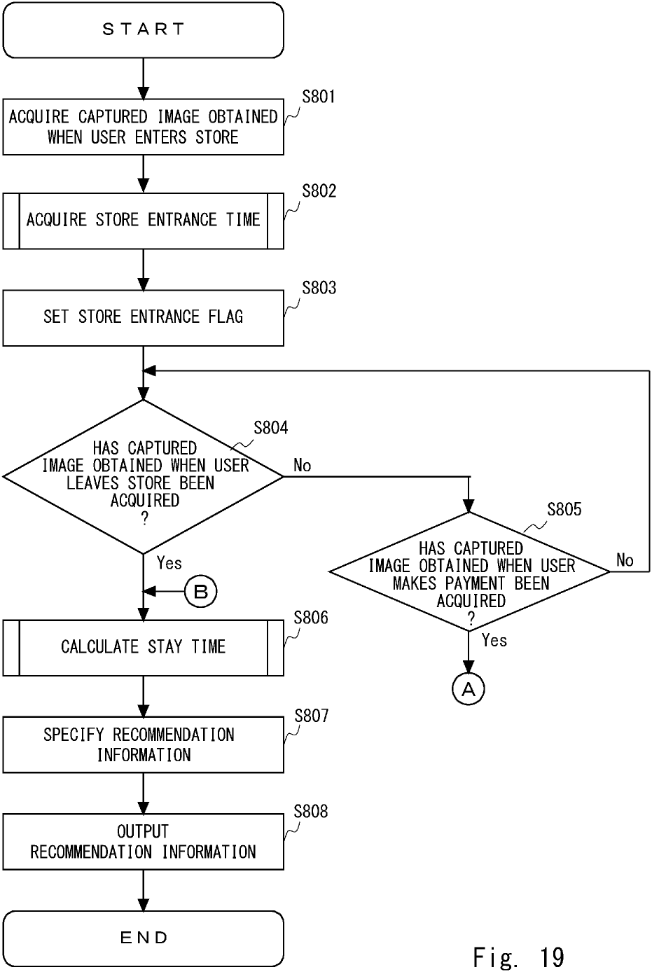

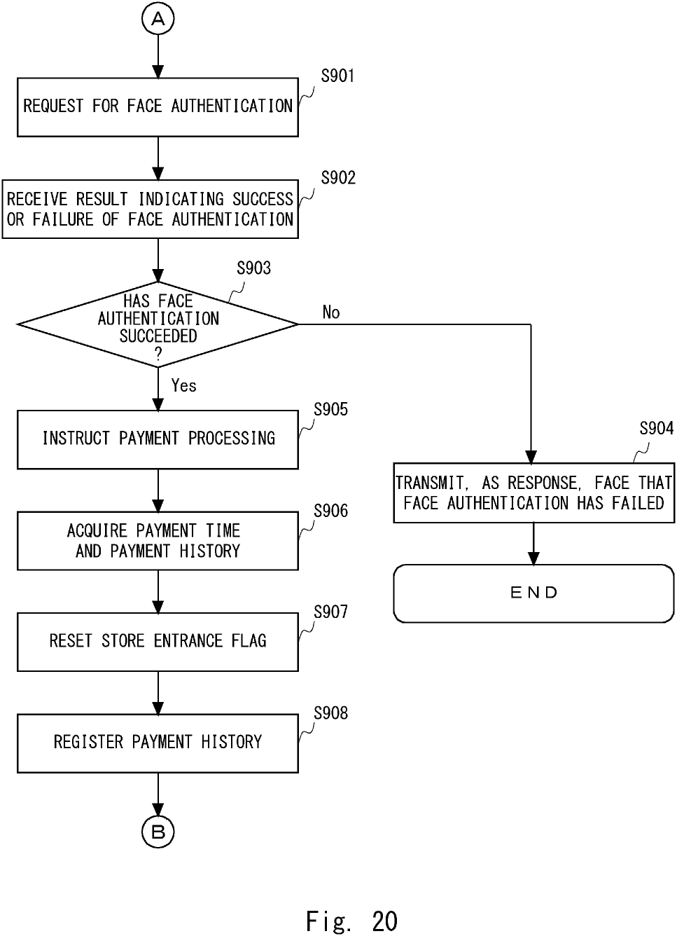

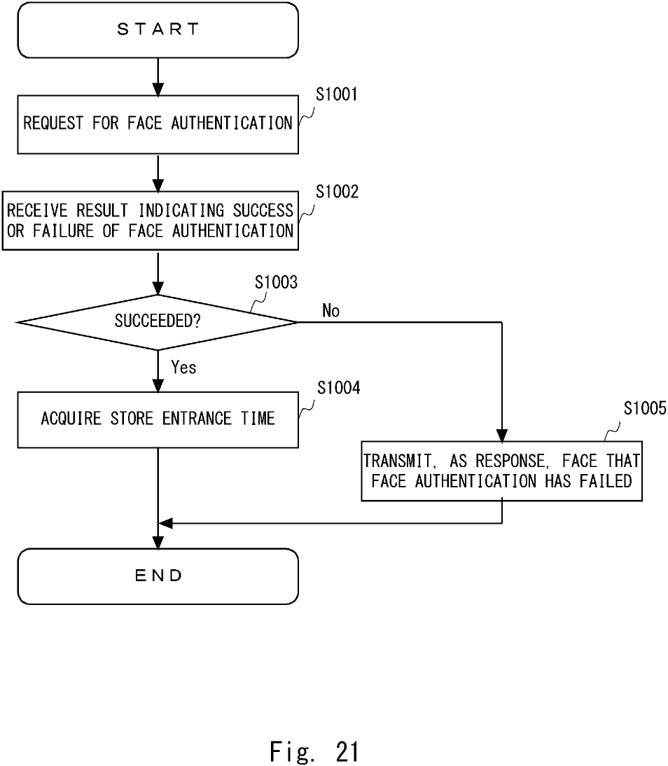

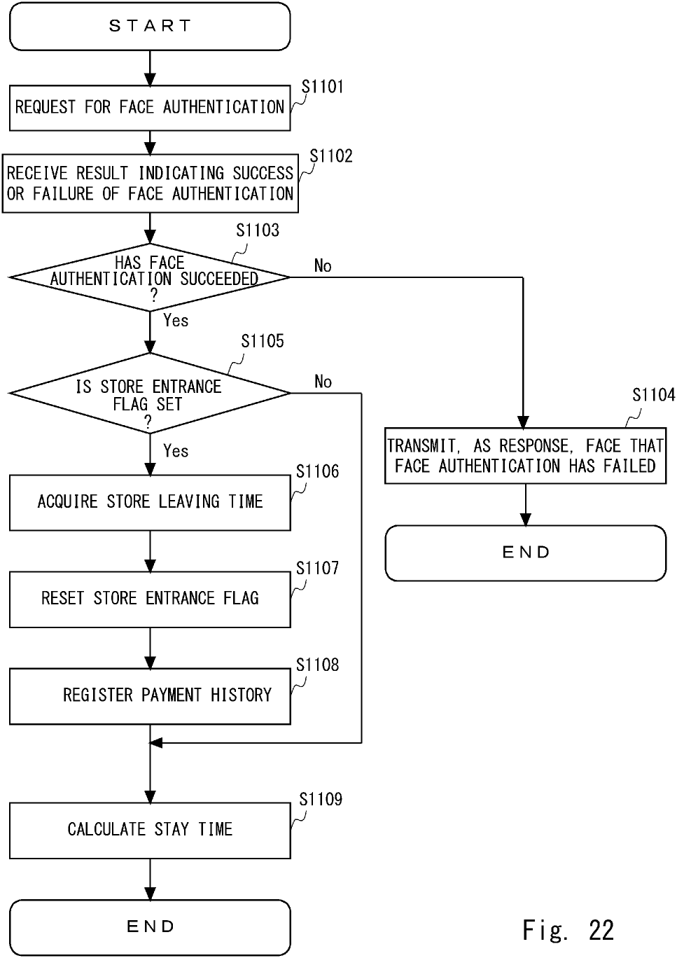

Next, an operation of the recommendation device 800a at the time of recommendation processing will be described with reference to FIGS. 19 to 22. FIGS. 19 and 20 are flowcharts illustrating a flow of recommendation processing. FIG. 21 is a flowchart illustrating a flow of store entrance time acquisition processing. FIG. 22 is a flowchart illustrating a flow of stay time calculation processing.

First, once a user enters the store X, the entrance camera 300a captures an image including a face of the user and transmits the captured image to the recommendation device 800a via the network 500. The authentication control unit 116 acquires the captured image (first captured image) obtained when the user enters the store by receiving the captured image from the entrance camera 300a (Step S801), and causes the authentication device 200 to perform the first face authentication. In a case where the first face authentication has succeeded, the first acquisition unit 112 acquires a store entrance time (first time) of the user (Step S802). Note that, in Step S802, the first acquisition unit 112 acquires an imaging time of the first captured image as the first time.

Next, the flag management unit 122 sets a store entrance flag of the user in the flag storage unit (Step S803). After entering the store X, the user leaves the store X after making payment in the store X or without making payment. At the time of payment, the payment terminal 400 captures an image including the face of the user and transmits the captured image to the recommendation device 800a via the network 500. At the time of leaving the store, the exit camera 300b captures an image including the face of the user, and transmits the captured image to the recommendation device 800a via the network 500. The captured image transmitted from the payment terminal 400 or the exit camera 300b is received by the authentication control unit 116.

In a case where the authentication control unit 116 has not acquired the captured image (third captured image) obtained when the user leaves the store (No in Step S804) and has not acquired the captured image (second captured image) obtained when the user makes payment (No in Step S805), it is considered that the user still stays in the store X. In a case where the authentication control unit 116 has acquired the third captured image (Yes in Step S804), the calculation unit 117 calculates a stay time (first stay time) of the user in the store X (Step S806). Next, the specifying unit 118 specifies recommendation information based on the first payment history and the first stay time (Step S807). Next, the output unit 119 outputs the recommendation information specified by the specifying unit 118 to the display terminal (Step S808).

An operation of the recommendation device 800a in a case where the authentication control unit 116 has not acquired the captured image (third captured image) obtained when the user leaves the store (No in Step S804) and has acquired the captured image (second captured image) obtained when the user makes payment (Yes in Step S805) will be described with reference to FIG. 20. First, once the second captured image is acquired, the authentication control unit 116 extracts a face region or face feature information from the second captured image. Then, the authentication control unit 116 transmits a face authentication request including the extracted face region or face feature information to the authentication device 200 (Step S901). The authentication device 200 performs the second face authentication based on the received face region or face feature information, and transmits, as a response, an authentication result to the recommendation device 800a. The authentication control unit 116 receives the result indicating the success or failure of the second face authentication (Step S902).

In a case where the second face authentication has failed (No in Step S903), the authentication control unit 116 transmits, as a response, the fact that the face authentication has failed to the second acquisition unit 114 (Step S904). In a case where the second face authentication has succeeded (Yes in Step S903), the second acquisition unit 114 instructs the payment terminal 400 to perform the payment processing (Step S905). Once the instruction for the payment processing is received, the payment terminal 400 performs the payment processing and transmits, as a response, the payment history, which is a result of the payment to the recommendation device 100a. The second acquisition unit 114 acquires a payment time and the payment history included in the payment history received from the payment terminal 400 as the payment time (second time) and the payment history (Step S906).

Next, the flag management unit 122 resets the store entrance flag of the user (Step S907). Next, the registration unit 115 registers the payment history acquired in Step S906 in the storage unit 120 (Step S908). After Step S908, the calculation unit 117 calculates the stay time of the user in the store X (Step S806).

Step S802 will be described in detail with reference to FIG. 21. First, once the first captured image is acquired, the authentication control unit 116 extracts a face region or face feature information from the first captured image. Then, the authentication control unit 116 transmits a face authentication request including the extracted face region or face feature information to the authentication device 200 (Step S1001). The authentication device 200 performs the first face authentication based on the received face region or face feature information, and transmits, as a response, an authentication result to the recommendation device 800a. The authentication control unit 116 receives the result indicating the success or failure of the first face authentication (Step S1002).

In a case where the first face authentication has succeeded (Yes in Step S1003), the first acquisition unit 112 acquires a time at which the first captured image is captured as the store entrance time of the user to the store X (Step S1004). In a case where the first face authentication has failed (No in Step S1003), the authentication control unit 116 transmits, as a response, the fact that the face authentication has failed to the first acquisition unit 112 (Step S1005).

Step S806 will be described in detail with reference to FIG. 22. First, once the third captured image is acquired, the authentication control unit 116 extracts a face region or face feature information from the third captured image. Then, the authentication control unit 116 transmits a face authentication request including the extracted face region or face feature information to the authentication device 200 (Step S1101). The authentication device 200 performs the third face authentication based on the received face region or face feature information, and transmits, as a response, an authentication result to the recommendation device 800a. The authentication control unit 116 receives the result indicating the success or failure of the third face authentication (Step S1102).

In a case where the third face authentication has failed (No in Step S1103), the authentication control unit 116 transmits, as a response, the fact that the face authentication has failed to the third acquisition unit 121 (Step S1104). In a case where the third face authentication has succeeded (Yes in Step S1103), the flag management unit 122 checks whether or not the store entrance flag of the user is set (Step S1105). In a case where the store entrance flag is set (Yes in Step S1105), the third acquisition unit 121 acquires a time at which the third captured image is captured as a store leaving time of the user from the store X (Step S1106). Next, the flag management unit 122 resets the store entrance flag of the user and updates the flag storage unit (Step S1107). Next, the registration unit 115 registers the fact that no payment has been made in the store X as the first payment history in the storage unit 120 (Step S1108). Note that, in Step S1108, information on the store that the user has entered and left is included in the payment history and registered in the storage unit 120.

Next, the calculation unit 117 calculates a stay time (first stay time) of the user in the store X (Step S1109). In a case where the store entrance flag is not set (No in Step S1105) and in a case where the payment history is registered in the storage unit 120 (Step S1108), the calculation unit 117 calculates the first stay time (Step S1109). As described above, since the store entrance flag of the user who has made payment is reset, the recommendation device 800a does not need to perform the third face authentication on the user when leaving the store X. That is, as the store entrance flag is provided, the number of targets for which the third face authentication is to be performed can be reduced. That is, only a user who has entered the store X and has not made payment is subjected to the third face authentication. Therefore, as the store entrance flag is provided, an authentication system of the third face authentication can be improved.

Hereinafter, a specific example of the recommendation condition and corresponding recommendation information will be described. For example, in a case where the recommendation condition is that “the stay time is one hour or more, and non-payment in a clothing store is included in the payment history”, the recommendation information is “guidance information to another clothing store”. A user staying for a long time and making no payment in a clothing store is considered to be interested in purchase of clothes, and have not found clothes that fit his/her taste in the clothing store that the user stayed. Therefore, it is possible to increase the utilization rate of the presented recommendation information by presenting the guide information to another clothing store to the user.

In a case where the recommendation condition is that “the stay time is one hour or more, and non-payment in an electric appliance store is included in the payment history”, the recommendation information is “a discount coupon of the electric appliance store”. The recommendation information may be “the next sale announcement of the electric appliance store” or the like. A user staying for a long time and making no payment in an electric appliance store is considered to be interested in a product of the electric appliance store but be hesitant to purchase. Therefore, it is possible to encourage the user to revisit the electric appliance store by presenting a discount coupon of the electric appliance store to the user.

In a case where the recommendation condition is that “the stay time is less than 15 minutes, and non-payment in a convenience store is included in the payment history”, the recommendation information is “a coffee discount coupon of a convenience store”. A user staying for a short time and making no payment in a convenience store is considered to have taken a cigarette break at the convenience store. Therefore, it is possible to increase the utilization rate of the presented recommendation information by presenting a coffee discount coupon to the user.

Since the recommendation device according to the present example embodiment can record the store leaving time even in a case where the user makes no payment in the store X, the stay time can be comprehensively calculated. Furthermore, the recommendation device according to the present example embodiment can achieve effects similar to the effects described in the first to third example embodiments.

### Fifth Example Embodiment

A fifth example embodiment is a modification of the fourth example embodiment described above. In the recommendation system 900 according to the fourth example embodiment, recommendation information is specified based on history information in a single store X. On the other hand, in the fifth example embodiment, recommendation information is specified based on history information in a plurality of stores.

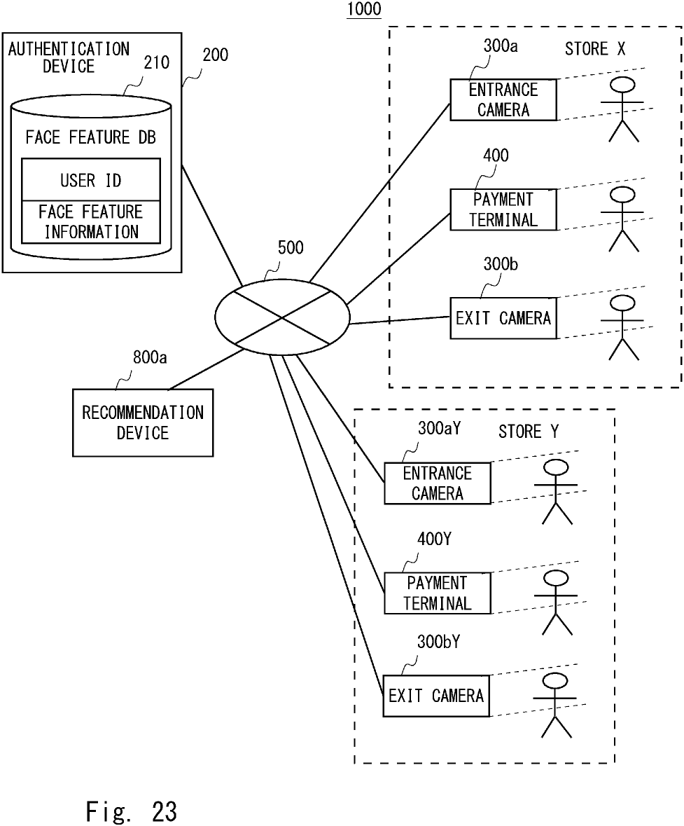

FIG. 23 is a block diagram illustrating a configuration of a recommendation system 1000 according to the fifth example embodiment. The recommendation system 1000 further includes an entrance camera 300aY, a payment terminal 400Y, and an exit camera 300bY in addition to the components of the recommendation system 900 illustrated in FIG. 17. For each component included in the recommendation system 1000, a description overlapping with that of the third or fourth example embodiment will be omitted as appropriate.

The entrance camera 300aY, the payment terminal 400Y, and the exit camera 300bY are installed in a store Y (second store). The store Y is a store different from the store X. For example, a user enters the store Y after leaving the store X. Since the configurations of the entrance camera 300aY, the payment terminal 400Y, and the exit camera 300bY are similar to the configurations of the entrance camera 300a, the payment terminal 400, and the exit camera 300b, a description thereof will be omitted.

In the present example embodiment, the authentication control unit 116 causes the authentication device 200 to perform face authentication based on captured images transmitted from the entrance camera 300aY, the payment terminal 400Y, and the exit camera 300bY. Once a user enters the second store (store Y), the entrance camera 300aY captures an image including a face of the user, and transmits the captured image to the recommendation device 800a via the network 500. The authentication control unit 116 acquires the captured image (first captured image) obtained when the user enters the second store by receiving the captured image from the entrance camera 300aY, and causes the authentication device 200 to perform the first face authentication. In a case where the first face authentication has succeeded, the first acquisition unit 112 acquires a store entrance time (first time) of the user to the second store. At this point, the first acquisition unit 112 acquires an imaging time of the first captured image as the first time.

Next, the flag management unit 122 sets a store entrance flag of the user in the flag storage unit. After entering the second store, the user makes payment in the second store or leaves the second store without making payment. At the time of payment, the payment terminal 400Y captures an image including the face of the user and transmits the captured image to the recommendation device 800a via the network 500. At the time of leaving the store, the exit camera 300bY captures an image including the face of the user, and transmits the captured image to the recommendation device 800a via the network 500. The captured image transmitted from the payment terminal 400Y or the exit camera 300bY is received by the authentication control unit 116.

In a case where the authentication control unit 116 has not acquired the captured image (third captured image) at the time of leaving the store and has not acquired the captured image (second captured image) at the time of payment, it is considered that the user still stays in the second store. In a case where the authentication control unit 116 has acquired the third captured image, the calculation unit 117 calculates a stay time (first stay time) of the user in the second store.

In a case where the second face authentication based on the image captured in the second store has succeeded, the registration unit 115 registers a second payment history in association with the user in the storage unit 120. The second payment history is a payment history of the user in the second store. The calculation unit 117 calculates a second stay time based on a difference between the first time and the second time in the second store. The second stay time is a stay time of the user in the second store. The specifying unit 118 specifies recommendation information based on a first combination and a second combination. A recommendation condition in the present example embodiment is the first combination and the second combination. The first combination is a combination of the first payment history and the first stay time. The second combination is a combination of the second payment history and the second stay time. Note that the first payment history and the second payment history may include information on a store where the payment has been made (for example, the genre of the store). Furthermore, the recommendation condition may include information on the first store and the second store. For example, the recommendation condition may or does not have to include a difference in genre between the first store and the second store.

Hereinafter, a specific example of the recommendation condition and corresponding recommendation information will be described. For example, in a case where the recommendation condition is that “the store X and the store Y are stores of different genres, and products of both stores are purchased”, the recommendation information is “introduction information of a store of another genre”. Note that the recommendation information may be “introduction information of a store of the same genre as the store X or the store Y”. A user visiting stores of different genres is considered to be not particular about the genre and be interested in products of various genres. Therefore, it is possible to present recommendation information of various genres to the user by presenting introduction information of stores of other genres to the user.

In a case where the recommendation condition is that “the genres of the store X and the store Y are the same, the first stay time is 30 minutes or more, the second stay time is less than 10 minutes, the first payment history is non-payment, and the second payment history includes a predetermined product”, the recommendation information is “similar product information”. A user staying in the first store for a long time and then staying in the second store for a short time and making payment is considered to have been spoilt for choice between the finally purchased product and a similar product. Therefore, it is possible to present recommendation information according to the user’s preference to the user by presenting several pieces of information of similar products side by side when the user searches for a product that the user is interested in the future.

The recommendation system according to the present example embodiment can specify recommendation information based on history information in a case where a user has visited a plurality of stores, and thus can present recommendation information better suited to the user’s taste. Furthermore, the recommendation device according to the present example embodiment can achieve effects similar to the effects described in the first to fourth example embodiments.

### Sixth Example Embodiment

A sixth example embodiment is a modification of the fifth example embodiment described above. In the recommendation system 1000 according to the fifth example embodiment, recommendation information is specified based on history information in a plurality of stores. On the other hand, in the sixth example embodiment, recommendation information is specified based on history information in which entering and leaving a store such as a street stall is not clear.

In the present example embodiment, for example, the entrance camera 300a and the exit camera 300b are installed at an entrance or the like (first point) of a shopping street including a street stall, and the payment terminal 400 is installed in the street stall (second point). There may be a plurality of street stalls. In addition, the present example embodiment is also suitable for a commercial building or the like including a street stall. Note that the authentication device 200 stores face feature information of a plurality of registered users in advance in association with user IDs of the plurality of registered users.

The entrance camera 300a captures the first captured image by imaging a user who has entered the shopping street through the first point. The entrance camera 300a transmits the first captured image to the recommendation device 800a via the network 500. In a case where the first face authentication at the first point has succeeded, the first acquisition unit 112 acquires the first time of the user. The payment terminal 400 captures an image including a face of the user who has made payment in the second point as the second captured image, and transmits the second captured image to the recommendation device 800a via the network 500. Once the second face authentication succeeds, the registration unit 115 registers, in the storage unit 120, a payment history based on the payment made by the user whose face authentication has succeeded in association with the user.

In a case where the second face authentication in the second point has succeeded, the second acquisition unit 114 acquires the second time of the user. The calculation unit 117 calculates a stay time of the user in the shopping street based on a difference between the first time and the second time. The specifying unit 118 identifies recommendation information based on the payment history and the stay time in the shopping street. The output unit 119 outputs the recommendation information specified by the specifying unit 118 to a display terminal. Note that, calculation of the stay time and specification and output of the recommendation information in a case where no payment is made may be performed as described above by using the third captured image obtained by the exit camera 300b.

The recommendation system according to the present example embodiment can specify recommendation information based on history information and a stay time even in a case where entrance and leaving of a user to and from a store is not clear. That is, even in a case where the stay time for each store is unclear, the recommendation system according to the present example embodiment can specify recommendation information based on the stay time in a shopping street, a shopping mall, or the like and the payment information in each store (tenant). Furthermore, the recommendation device according to the present example embodiment can achieve effects similar to the effects described in the first to fifth example embodiments.

### Seventh Example Embodiment

A seventh example embodiment is a modification of the first to sixth example embodiments described above. In the recommendation systems 700, 900, and 1000 according to the first to sixth example embodiments, recommendation information is presented immediately after payment or immediately after leaving a store. On the other hand, in the seventh example embodiment, recommendation information is presented according to designation made by a user.

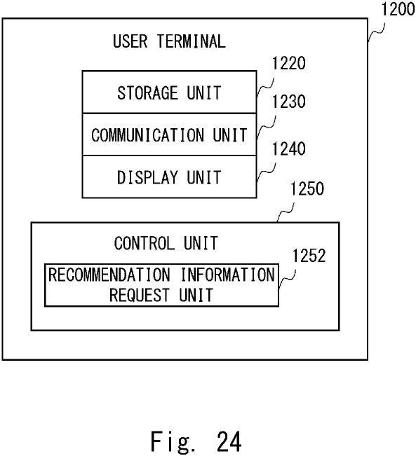

FIG. 24 is a block diagram illustrating a configuration of a user terminal. A user terminal 1200 is a communication terminal such as a smartphone carried by a user. The user terminal 1200 includes at least a display device and a computer as hardware components. The user terminal 1200 includes a storage unit 1220, a communication unit 1230, a display unit 1240, and a control unit 1250. The storage unit 1220 is a storage device that stores a program for implementing each function of the user terminal 1200. The communication unit 1230 is a communication interface with the network 500. The display unit 1240 is a display device that displays a face authentication result, recommendation information, and the like to a user. The control unit 1250 controls hardware included in the user terminal 1200. The control unit 1250 includes a recommendation information requesting unit 1252. The recommendation information requesting unit 1252 transmits a recommendation information request to the recommendation device 100a via the network 500. The recommendation information request includes a user ID of the user.

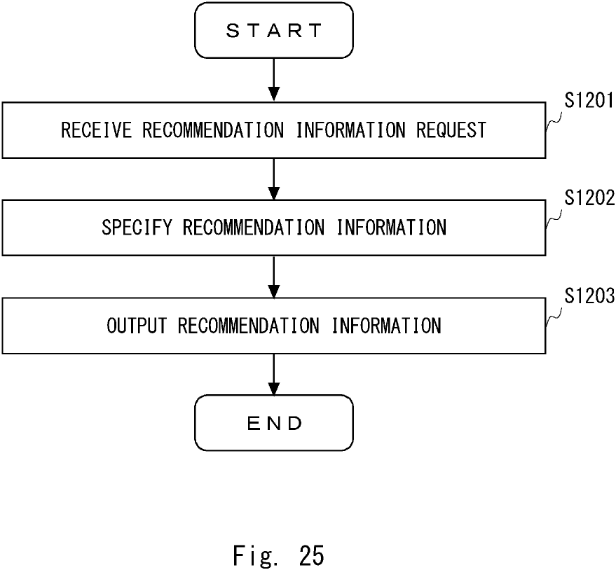

An operation of the recommendation device 100a when the recommendation information request is received will be described with reference to FIG. 25. FIG. 25 is a flowchart illustrating a flow of recommendation processing. Once the recommendation information request is received (Step S1201), the specifying unit 118 identifies recommendation information based on the first payment history and the first stay time corresponding to the user ID included in the recommendation information request (Step S1202). Next, the output unit 119 outputs the recommendation information specified by the specifying unit 118 to the user terminal 1200 (Step S1203).

The recommendation system according to the present example embodiment can present recommendation information at a timing desired by a user. Furthermore, the recommendation device according to the present example embodiment can achieve effects similar to the effects described in the first to sixth example embodiments.

Note that, although the hardware configuration has been described in the above-described example embodiments, the present disclosure is not limited thereto. According to the present disclosure, arbitrary processing can also be implemented by causing a CPU to execute a computer program.

In the above example, the program may be stored using various types of non-transitory computer-readable media and supplied to a computer. The non-transitory computer-readable media include various types of tangible storage media. Examples of the non-transitory computer-readable medium include a magnetic recording medium (for example, a flexible disk, a magnetic tape, or a hard disk drive), an optical magnetic recording medium (for example, a magnetooptical disk), a compact disc-read only memory (CD-ROM), a CD-R, a CD-R/W, a digital versatile disc (DVD), and a semiconductor memory such as a mask ROM, a programmable ROM (PROM), an erasable PROM (EPROM), a flash ROM, or a random access memory (RAM). In addition, the program may be supplied to the computer by various types of transitory computer-readable media. Examples of the transitory computer-readable medium include an electric signal, an optical signal, and electromagnetic waves. The transitory computer-readable medium can provide the program to the computer via a wired communication line such as electric wires and optical fibers or a wireless communication line.

Note that the present disclosure is not limited to the above example embodiments, and can be appropriately changed without departing from the gist. Furthermore, the present disclosure may be implemented by appropriately combining the respective example embodiments.

The whole or part of the example embodiments disclosed above can be described as, but not limited to, the following Supplementary Notes.

### Supplementary Note A1

A recommendation device including:
a first acquisition unit configured to acquire a first time that is an entrance time to a first store in a case where first face authentication using an authentication device that stores face feature information of a plurality of registered users in advance has succeeded for a first captured image obtained by imaging a predetermined user when the user enters the first store;
a second acquisition unit configured to acquire a second time that is a payment time in a case where second face authentication using the authentication device has succeeded for a second captured image obtained by imaging the user when the user makes payment in the first store;
a registration unit configured to register a first payment history based on the payment in association with the user in storage means in a case where the second face authentication has succeeded;
a calculation unit configured to calculate a first stay time of the user in the first store based on a difference between the first time and the second time;
a specifying unit configured to specify recommendation information based on the first payment history and the first stay time; and
an output unit configured to output the specified recommendation information.

### Supplementary Note A2

The recommendation device according to Supplementary Note A1, in which the specifying unit specifies, as the recommendation information, arrival information regarding a purchase content included in the first payment history in a case where the first stay time is shorter than a predetermined time.

### Supplementary Note A3

The recommendation device according to Supplementary Note A1 or A2, further including a third acquisition unit configured to acquire, as the second time, a third time that is a leaving time from the first store in a case where third face authentication using the authentication device has succeeded for a third captured image obtained by imaging the user when the user leaves the first store, and the user has made no payment in the first store,

in which the registration unit registers, as the first payment history, a fact that no payment has been made in the first store in the storage unit in a case where the third time has been acquired.

### Supplementary Note A4

The recommendation device according to Supplementary Note A3, further including:
a flag storage unit configured to store a store entrance flag of the user; and
a flag management unit configured to set the store entrance flag of the user and registering the store entrance flag in the flag storage unit in a case where the first face authentication has succeeded, and resetting the store entrance flag of the user and updating the flag storage unit in a case where the second face authentication has succeeded, in which
in a case where the store entrance flag of the user is set in the flag storage unit, the third acquisition unit considers that the user has made no payment in the first store,
the flag management unit resets the store entrance flag and updates the flag storage unit in a case where the third face authentication has succeeded and the store entrance flag of the user is set in the flag storage unit, and
the calculation unit calculates the first stay time in a case where the store entrance flag of the user has been reset.

### Supplementary Note A5

The recommendation device according to Supplementary Note A3 or A4, in which the specifying unit specifies the recommendation information for recommending a store other than the first store in a case where the first stay time is longer than a predetermined time and the first payment history indicates that no payment has been made.

### Supplementary Note A6

The recommendation device according to Supplementary Note A3 or A4, in which the specifying unit specifies discount information of the first store as the recommendation information in a case where the first stay time is longer than a predetermined time and the first payment history indicates that no payment has been made.

### Supplementary Note A7

The recommendation device according to any one of Supplementary Notes A1 to A6, in which
the registration unit further registers a second payment history based on payment made by the user in a second store that the user has entered after leaving the first store, in association with the user,
the calculation unit further calculates a second stay time of the user in the second store, and
the specifying unit specifies the recommendation information based on a first combination of the first payment history and the first stay time, and a second combination of the second payment history and the second stay time.

### Supplementary Note A8

The recommendation device according to any one of Supplementary Notes A1 to A7, in which
the specifying unit specifies, in a case where a recommendation request including a user ID of the user has been received from a user terminal, the recommendation information based on the first payment history and the first stay time corresponding to the user ID, and
the output unit outputs the specified recommendation information to the user terminal.

### Supplementary Note B1

A recommendation device including:
calculation means for calculating a stay time of a user in a store;
specifying means for specifying recommendation information to be presented to the user based on the stay time; and
output means for outputting the specified recommendation information.

### Supplementary Note C1

A recommendation system including:
an imaging device configured to capture an image including a face region of a predetermined user;
a payment terminal configured to perform payment for the user;
a recommendation device configured to be communicable with the imaging device and the payment terminal; and
an authentication device configured to store face feature information of the user and be communicable with the recommendation device,
in which the recommendation device includes:
a first acquisition unit configured to acquire a first time that is an entrance time to a first store in a case where first face authentication using an authentication device that stores face feature information of a plurality of registered users in advance has succeeded for a first captured image obtained by imaging a predetermined user when the user enters the first store;
a second acquisition unit configured to acquire a second time that is a payment time in a case where second face authentication using the authentication device has succeeded for a second captured image obtained by imaging the user when the user makes payment in the first store;
a registration unit configured to register a first payment history based on the payment in association with the user in storage means in a case where the second face authentication has succeeded;
a calculation unit configured to calculate a first stay time of the user in the first store based on a difference between the first time and the second time;
a specifying unit configured to specify recommendation information based on the first payment history and the first stay time; and
an output unit configured to output the specified recommendation information.

### Supplementary Note C2

The recommendation system according to Supplementary Note C1, in which the specifying unit specifies, as the recommendation information, arrival information regarding a purchase content included in the first payment history in a case where the first stay time is shorter than a predetermined time.

### Supplementary Note D1

A recommendation method performed by a computer, the recommendation method including:
acquiring a first time that is an entrance time to a first store in a case where first face authentication using an authentication device that stores face feature information of a plurality of registered users in advance has succeeded for a first captured image obtained by imaging a predetermined user when the user enters the first store;
acquiring a second time that is a payment time in a case where second face authentication using the authentication device has succeeded for a second captured image obtained by imaging the user when the user makes payment in the first store;
registering a first payment history based on the payment in association with the user in storage means in a case where the second face authentication has succeeded;
calculating a first stay time of the user in the first store based on a difference between the first time and the second time;
specifying recommendation information based on the first payment history and the first stay time; and
outputting the specified recommendation information.

### Supplementary Note E1

A non-transitory computer-readable medium storing a recommendation program that causes a computer to perform:
acquiring a first time that is an entrance time to a first store in a case where first face authentication using an authentication device that stores face feature information of a plurality of registered users in advance has succeeded for a first captured image obtained by imaging a predetermined user when the user enters the first store;
acquiring a second time that is a payment time in a case where second face authentication using the authentication device has succeeded for a second captured image obtained by imaging the user when the user makes payment in the first store;
registering a first payment history based on the payment in association with the user in storage means in a case where the second face authentication has succeeded;
calculating a first stay time of the user in the first store based on a difference between the first time and the second time;
specifying recommendation information based on the first payment history and the first stay time; and
outputting the specified recommendation information.

### Supplementary Note F1

A recommendation device including:
a first authentication unit configured to perform first face authentication by using face feature information of a plurality of registered users stored in advance, for a first captured image obtained by imaging a predetermined user when the user enters a first store;
a first acquisition unit configured to acquire a first time that is an entrance time to the first store in a case where the first face authentication has succeeded;
a second authentication unit configured to perform second face authentication by using the face feature information of the plurality of registered users, for a second captured image obtained by imaging the user when the user makes payment in the first store;
a second acquisition unit configured to acquire a second time that is a payment time in a case where the second face authentication has succeeded;
a registration unit configured to register a first payment history based on the payment in association with the user in storage means in a case where the second face authentication has succeeded;
a calculation unit configured to calculate a first stay time of the user in the first store based on a difference between the first time and the second time;
a specifying unit configured to specify recommendation information based on the first payment history and the first stay time; and
an output unit configured to output the specified recommendation information.

### Supplementary Note F2

The recommendation device according to Supplementary Note F1, in which the specifying unit specifies, as the recommendation information, arrival information regarding a purchase content included in the first payment history in a case where the first stay time is shorter than a predetermined time.

### Supplementary Note G1

A recommendation method performed by a computer, the recommendation method including:
performing first face authentication by using face feature information of a plurality of registered users stored in advance, for a first captured image obtained by imaging a predetermined user when the user enters a first store;
acquiring a first time that is an entrance time to the first store in a case where the first face authentication has succeeded;
performing second face authentication by using the face feature information of the plurality of registered users, for a second captured image obtained by imaging the user when the user makes payment in the first store;
acquiring a second time that is a payment time in a case where the second face authentication has succeeded;
registering a first payment history based on the payment in association with the user in storage means in a case where the second face authentication has succeeded;
calculating a first stay time of the user in the first store based on a difference between the first time and the second time;
specifying recommendation information based on the first payment history and the first stay time; and
outputting the specified recommendation information.

### Supplementary Note H1

A non-transitory computer-readable medium storing a recommendation program that causes a computer to perform:
performing first face authentication by using face feature information of a plurality of registered users stored in advance, for a first captured image obtained by imaging a predetermined user when the user enters a first store;
acquiring a first time that is an entrance time to the first store in a case where the first face authentication has succeeded;
performing second face authentication by using the face feature information of the plurality of registered users, for a second captured image obtained by imaging the user when the user makes payment in the first store;
acquiring a second time that is a payment time in a case where the second face authentication has succeeded;
registering a first payment history based on the payment in association with the user in storage means in a case where the second face authentication has succeeded;
calculating a first stay time of the user in the first store based on a difference between the first time and the second time;
specifying recommendation information based on the first payment history and the first stay time; and
outputting the specified recommendation information.

Although the present invention has been described with reference to the example embodiments (and examples), the present invention is not limited to the above example embodiments (and examples). Various modifications that can be understood by those skilled in the art can be made to the configuration and details of the present invention within the scope of the present invention.

### Reference Signs List

100, 100a, 600, 800a RECOMMENDATION DEVICE
700, 900, 1000 RECOMMENDATION SYSTEM
110 CONTROL UNIT
111 FIRST AUTHENTICATION UNIT
112 FIRST ACQUISITION UNIT
113 SECOND AUTHENTICATION UNIT
114 SECOND ACQUISITION UNIT
115 REGISTRATION UNIT
116 AUTHENTICATION CONTROL UNIT
117 CALCULATION UNIT
118 SPECIFYING UNIT
119 OUTPUT UNIT
120 STORAGE UNIT
121 THIRD ACQUISITION UNIT
122 FLAG MANAGEMENT UNIT
130 MEMORY
140 COMMUNICATION UNIT
160 SPECIFYING UNIT
170 OUTPUT UNIT
200 AUTHENTICATION DEVICE
220 FACE DETECTION UNIT
230 FEATURE POINT EXTRACTION UNIT
240 REGISTRATION UNIT
250 AUTHENTICATION UNIT
300 FACE AUTHENTICATION TERMINAL
300a, 300aY ENTRANCE CAMERA
300b, 300bY EXIT CAMERA
350 DISPLAY UNIT
400, 400Y PAYMENT TERMINAL
410 CAMERA
420 STORAGE UNIT
430 COMMUNICATION UNIT
440 DISPLAY UNIT
450 CONTROL UNIT
452 IMAGING UNIT
453 REGISTRATION UNIT
454 AUTHENTICATION UNIT
455 PAYMENT UNIT
500 NETWORK
1200 USER TERMINAL
1220 STORAGE UNIT
1230 COMMUNICATION UNIT
1240 DISPLAY UNIT
1250 CONTROL UNIT
1252 RECOMMENDATION INFORMATION REQUESTING UNIT

What is claimed is:

1. A recommendation device comprising:
at least one memory acquiring storing instructions and
at least one processor configured to execute the instructions to;
acquire a first time that is an entrance time to a first store in a case where first face authentication using an authentication device that stores face feature information of a plurality of registered users in advance has succeeded for a first captured image obtained by imaging a predetermined user when the user enters the first store;
acquire a second time that is a payment time in a case where second face authentication using the authentication device has succeeded for a second captured image obtained by imaging the user when the user makes payment in the first store;
register a first payment history based on the payment in association with the user in the at least one memory in a case where the second face authentication has succeeded;
calculate a first stay time of the user in the first store based on a difference between the first time and the second time;
specify recommendation information based on the first payment history and the first stay time; and
output the specified recommendation information.

2. The recommendation device according to claim 1, wherein the at least one processor is further configured to execute the instructions to the specify, as the recommendation information, arrival information regarding a purchase content included in the first payment history in a case where the first stay time is shorter than a predetermined time.

3. The recommendation device according to claim 1, the at least one processor is further configured to execute the instructions to acquire, as the second time, a third time that is a leaving time from the first store in a case where third face authentication using the authentication device has succeeded for a third captured image obtained by imaging the user when the user leaves the first store, and the user has made no payment in the first store,
wherein the at least one processor registers, as the first payment history, a fact that no payment has been made in the first store in the at least one memory in a case where the third time has been acquired.

4. The recommendation device according to claim 3, wherein,
the at least one memory is configured to store entrance flag of the user; and
the at least one processor is further configured to execute the instructions to:
set the store entrance flag of the user and registering the store entrance flag in the at least one memory in a case where the first face authentication has succeeded, and resetting the store entrance flag of the user and updating the at least one memory in a case where the second face authentication has succeeded, wherein
in a case where the store entrance flag of the user is set in the at least one memory, consider that the user has made no payment in the first store,
reset the store entrance flag and updates the at least one memory in a case where the third face authentication has succeeded and the store entrance flag of the user is set in the at least one memory, and
calculate the first stay time in a case where the store entrance flag of the user has been reset.

5. The recommendation device according to claim 3, wherein the at least one processor is further configured to execute the instructions to specify the recommendation information for recommending a store other than the first store in a case where the first stay time is longer than a predetermined time and the first payment history indicates that no payment has been made.

6. The recommendation device according to claim 3, wherein the at least one processor is further configured to execute the instructions to specify discount information of the first store as the recommendation information in a case where the first stay time is longer than a predetermined time and the first payment history indicates that no payment has been made.

7. The recommendation device according to claim 1, wherein the at least one processor is further configured to execute the instructions to:
register a second payment history based on payment made by the user in a second store that the user has entered after leaving the first store, in association with the user,
calculate a second stay time of the user in the second store, and
specify the recommendation information based on a first combination of the first payment history and the first stay time, and a second combination of the second payment history and the second stay time.

8. The recommendation device according to claim 1, wherein the at least one processor is further configured to execute the instructions to:
specify, in a case where a recommendation request including a user ID of the user has been received from a user terminal, the recommendation information based on the first payment history and the first stay time corresponding to the user ID, and
output the specified recommendation information to the user terminal.

9. A recommendation device comprising:
at least one memory acquiring storing instructions and
at least one processor configured to execute the instructions to;
calculate a stay time of a user in a store;
specify recommendation information to be presented to the user based on the stay time; and
output the specified recommendation information.

10. A recommendation system comprising:
an imaging device configured to capture an image including a face region of a predetermined user;
a payment terminal configured to perform payment for the user;
a recommendation device configured to be communicable with the imaging device and the payment terminal; and
an authentication device configured to store face feature information of the user and be communicable with the recommendation device,
wherein the recommendation device includes:
first acquisition means for acquiring a first time that is an entrance time to a first store in a case where first face authentication using an authentication device that stores face feature information of a plurality of registered users in advance has succeeded for a first captured image obtained by imaging a predetermined user when the user enters the first store;
second acquisition means for acquiring a second time that is a payment time in a case where second face authentication using the authentication device has succeeded for a second captured image obtained by imaging the user when the user makes payment in the first store;
registration means for registering a first payment history based on the payment in association with the user in storage means in a case where the second face authentication has succeeded;
calculation means for calculating a first stay time of the user in the first store based on a difference between the first time and the second time;
specifying means for specifying recommendation information based on the first payment history and the first stay time; and
output means for outputting the specified recommendation information.

11. The recommendation system according to claim 10, wherein the specifying means specifies, as the recommendation information, arrival information regarding a purchase content included in the first payment history in a case where the first stay time is shorter than a predetermined time.

12. A recommendation method performed by a computer, the recommendation method comprising:
acquiring a first time that is an entrance time to a first store in a case where first face authentication using an authentication device that stores face feature information of a plurality of registered users in advance has succeeded for a first captured image obtained by imaging a predetermined user when the user enters the first store;
acquiring a second time that is a payment time in a case where second face authentication using the authentication device has succeeded for a second captured image obtained by imaging the user when the user makes payment in the first store;
registering a first payment history based on the payment in association with the user in storage means in a case where the second face authentication has succeeded;
calculating a first stay time of the user in the first store based on a difference between the first time and the second time;
specifying recommendation information based on the first payment history and the first stay time; and
outputting the specified recommendation information.

13. A non-transitory computer-readable medium storing a recommendation program that causes a computer to perform:
acquiring a first time that is an entrance time to a first store in a case where first face authentication using an authentication device that stores face feature information of a plurality of registered users in advance has succeeded for a first captured image obtained by imaging a predetermined user when the user enters the first store;
acquiring a second time that is a payment time in a case where second face authentication using the authentication device has succeeded for a second captured image obtained by imaging the user when the user makes payment in the first store;
registering a first payment history based on the payment in association with the user in storage means in a case where the second face authentication has succeeded;
calculating a first stay time of the user in the first store based on a difference between the first time and the second time;
specifying recommendation information based on the first payment history and the first stay time; and
outputting the specified recommendation information.

14. A recommendation device comprising:
at least one memory acquiring storing instructions and
at least one processor configured to execute the instructions to;
perform first face authentication by using face feature information of a plurality of registered users stored in advance, for a first captured image obtained by imaging a predetermined user when the user enters a first store;
acquire a first time that is an entrance time to the first store in a case where the first face authentication has succeeded;
perform second face authentication by using the face feature information of the plurality of registered users, for a second captured image obtained by imaging the user when the user makes payment in the first store;
acquire a second time that is a payment time in a case where the second face authentication has succeeded;
register a first payment history based on the payment in association with the user in the at least one memory in a case where the second face authentication has succeeded;
calculate a first stay time of the user in the first store based on a difference between the first time and the second time;
specify recommendation information based on the first payment history and the first stay time; and
output the specified recommendation information.

15. The recommendation device according to claim 14, wherein at least one processor configured to execute the instructions to specify ,as the recommendation information, arrival information regarding a purchase content included in the first payment history in a case where the first stay time is shorter than a predetermined time.

16. A recommendation method performed by a computer, the recommendation method comprising:
performing first face authentication by using face feature information of a plurality of registered users stored in advance, for a first captured image obtained by imaging a predetermined user when the user enters a first store;
acquiring a first time that is an entrance time to the first store in a case where the first face authentication has succeeded;
performing second face authentication by using the face feature information of the plurality of registered users, for a second captured image obtained by imaging the user when the user makes payment in the first store;
acquiring a second time that is a payment time in a case where the second face authentication has succeeded;
registering a first payment history based on the payment in association with the user in storage means in a case where the second face authentication has succeeded;
calculating a first stay time of the user in the first store based on a difference between the first time and the second time;
specifying recommendation information based on the first payment history and the first stay time; and
outputting the specified recommendation information.

17. A non-transitory computer-readable medium storing a recommendation program that causes a computer to perform:
performing first face authentication by using face feature information of a plurality of registered users stored in advance, for a first captured image obtained by imaging a predetermined user when the user enters a first store;
acquiring a first time that is an entrance time to the first store in a case where the first face authentication has succeeded;
performing second face authentication by using the face feature information of the plurality of registered users, for a second captured image obtained by imaging the user when the user makes payment in the first store;
acquiring a second time that is a payment time in a case where the second face authentication has succeeded;
registering a first payment history based on the payment in association with the user in storage means in a case where the second face authentication has succeeded;
calculating a first stay time of the user in the first store based on a difference between the first time and the second time;
specifying recommendation information based on the first payment history and the first stay time; and
outputting the specified recommendation information.
